(19) United States
(12) Patent Application Publication
(10) Pub. No.: US 2024/0095506 A1
(43) Pub. Date: Mar. 21, 2024

(54) CLIFFORD NEURAL LAYERS FOR MULTIVECTOR SYSTEM MODELING

(71) Applicant: Microsoft Technology Licensing, LLC, Redmond, WA (US)

(72) Inventors: Johannes BRANDSTETTER, Amsterdam (NL); Max Welling, Redmond, WA (US); Jayesh Kumar Gupta, Redmond, WA (US)

(21) Appl. No.: 18/087,357

(22) Filed: Dec. 22, 2022

Related U.S. Application Data
(60) Provisional application No. 63/404,810, filed on Sep. 8, 2022.

(51) Int. Cl. G06N 3/063; G06N 20/10

(52) U.S. Cl. CPC G06N 3/063; G06N 20/10

(57) ABSTRACT

Generally discussed herein are devices, systems, and methods for machine learning (ML) modeling of a system that operates on a multivector object. A method includes receiving, by an ML model, the multivector object as an input that represents a state of the multivector system. The method includes operating, by the ML model and using a Clifford layer that includes neurons that implement a multivector kernel, on the multivector input to generate a multivector output that represents the state of the multivector system responsive to the multivector input.

### RELATED APPLICATION

This application claims the benefit of priority under 35 U.S.C. § 119(e), to U.S. Provisional Patent Application Ser. No. 63/404,810, titled “CLIFFORD NEURAL LAYERS FOR MULTI-VECTOR SYSTEM MODEL” filed on Sep. 8, 2022, which is hereby incorporated by reference in its entirety.

### BACKGROUND

Current machine learning (ML) models operate on a standard vector or scalar

input. A vector includes multiple scalar entries.

### SUMMARY

A device, system, method, and computer-readable medium configured for implementing an ML model that operates on a multivector input are provided. The ML model can implement a multivector valued neural network (NN) which operates on multivector inputs. Clifford algebras are used to define how to operate on and between multivector objects. The output can be a multivector, classification, vector, or the like. One or more of a Clifford convolution layer, a Clifford Fourier transform layer, and an equivariant Clifford layer can be used to operate on the multivector input. Examples of systems that are modeled using multivectors include mechanical engineering, civil engineering, geophysics, or meteorology that use fluid dynamics (e.g., two-dimensional (2D) Navier-Stokes equations), electric, optical, or radio technologies that rely on solving three-dimensional (3D) Maxwell equations, and the modeling of other physical systems in general.

### BRIEF DESCRIPTION OF DRAWINGS

FIG. 1 illustrates, by way of example, a diagram of an embodiment of an ML system 100 for operating on a multivector object input 102.

FIG. 2 illustrates, by way of example, a diagram of the spatial primitives of the multivector object and an example multivector object.

FIG. 3 illustrates a first vector field that represents some physical phenomena.

FIG. 4 illustrates, by way of example, a vector field generated by decomposing the vector field into respective x and y Fourier transforms and then attempting to reconstruct the vector field from the Fourier transforms.

FIG. 5 illustrates, by way of example, a vector field generated by treating the vectors field as a multivector object, performing a Clifford Fourier transform, using a Clifford Fourier layer, on the multivector object, and then reconstructing the vector field from the Clifford Fourier transform.

FIG. 6 illustrates, by way of example, a diagram of an embodiment of a Clifford convolution layer.

FIG. 7 illustrates, by way of example, a diagram of an embodiment of a Clifford Fourier Neural Operator (CFNO) layer.

FIG. 8 shows example rollouts of the scalar and the vector field components obtained by Clifford Fourier PDE surrogates for a qualitative comparison.

FIG. 9 illustrates, by way of example, graphs of one-step loss and rollout loss for a variety of NN PDE modeling architectures implementing Navier-Stokes equation.

FIG. 10 illustrates, by way of example, MSE loss for one-step and rollout for various NN architectures implementing Navier-Stokes equations.

FIG. 11 illustrates, by way of example, graphs of MSE versus number of training trajectories for FNO and CFNO NN architectures for Maxwell's Equations simulations.

FIG. 12 illustrates, by way of example, a diagram of an embodiment of a method for multivector object system modeling.

FIG. 13 is a block diagram of an example of an environment including a system for neural network training

FIG. 14 illustrates, by way of example, a block diagram of an embodiment of a machine (e.g., a computer system) to implement one or more embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the embodiments. It is to be understood that other embodiments may be utilized and that structural, logical, and/or electrical changes may be made without departing from the scope of the embodiments. The following description of embodiments is, therefore, not to be taken in a limited sense, and the scope of the embodiments is defined by the appended claims

Some systems are classically modeled using standard vectors and scalars. These systems can benefit from modeling using multivector objects. The elements of a Clifford algebra are called multivectors or multivector objects. Multivector objects contain elements of subspaces (e.g., scalars, vectors, bivectors, trivectors, etc.). The geometric product is an operation which combines multivector objects such that the result is another multivector object. Embodiments can use multivector kernels to define convolutions over multivector object inputs. Embodiments can use the geometric product in the Fourier space to define Clifford Fourier layers over multivector objects.

The values of a given element of a multivector object are dependent on one or more values of other elements of the multivector object. No single, current ML model accounts for such diverse input elements or dependencies between the elements. Embodiments operate with neural network (NN) elements that operate using a Clifford algebra. This is in contrast to normal NN elements that operate on wx+b using an activation function, where w is a learned weight, x is a vector or scalar input value (but not a combination thereof), and b is a bias.

An application of Clifford neural layers is modeling through solving partial differential equations (PDEs). PDEs have significant use in science and engineering. PDEs simulate physical processes as scalar and vector fields interacting and coevolving over time. Due to the computationally expensive nature of standard PDE solution methods, neural PDE surrogates have become an active research topic to accelerate these simulations. However, current methods do not explicitly take into account the relationship between different fields and their internal components, which are often correlated. Modeling the time evolution of such correlated fields using multivector fields accounts for the relationship between different fields and their internal components. Multivector fields can include scalar, vector, as well as higher-order components, such as bivectors and trivectors. Algebraic properties of multivector fields, such as multiplication, addition, and other arithmetic operations can be described by Clifford algebras. Embodiments present the first usage of such multivector representations together with Clifford convolutions and Clifford Fourier transforms in the context of deep learning (DL). Resulting Clifford neural layers are universally applicable and can be used in the areas of fluid dynamics, weather forecasting, and the modeling of physical systems in general. Empirical evaluation of the benefit of Clifford neural layers is explored by replacing convolution and Fourier operations in common neural PDE surrogates with their Clifford counterparts. The PDE surrogates analyzed include two-dimensional Navier-Stokes and weather modeling tasks, as well as three-dimensional Maxwell equations. Clifford neural layers consistently improve generalization capabilities of the tested neural PDE surrogates.

Most scientific phenomena are described by the evolution and interaction of physical quantities over space and time. The concept of fields is one widely used construct to continuously parameterize these quantities over chosen coordinates. Prominent examples include (i) fluid mechanics, which has applications in domains ranging from mechanical and civil engineering, to geophysics and meteorology, and (ii) electromagnetism, which provides mathematical models for electric, optical, or radio technologies. The underlying equations of these examples are described in various forms of the Navier-Stokes equations and Maxwell's equations. For the majority of these equations, solutions are analytically intractable, and obtaining accurate predictions necessitates falling back on numerical approximation schemes often with prohibitive computation costs. DL's success at overcoming the curse of dimensionality in many fields has led to a surge of interest in scientific applications, especially at augmenting and replacing numerical solving schemes in fluid dynamics with neural networks.

Weather simulations are used to ground further description. In weather simulations, two different kinds of fields emerge: scalar fields such as temperature or humidity, and vector fields such as wind velocity or pressure gradients. Current DL-based approaches treat different vector field components the same as scalar fields, and stack all scalar fields along the channel dimension, thereby omitting the geometric relations between different components, both within vector fields as well as between individual vector and scalar fields. This practice leaves out important inductive bias information present in the input data. For example, wind velocities in the x- and y-directions are strongly related, such that they form a vector field. Additionally, the wind vector field and the scalar pressure field are related since the gradient of the pressure field causes air movement and subsequently influences the wind components. In this work, neural PDE surrogates are built which not only model local and global relationships, as current methods do, but also the relation between different fields (e.g., wind and pressure field) and field components (e.g. x- and y-component of the wind velocities).

| | |
|---|---|
| e₁, e₂, e₃ | Basis vectors of the generating vector space of the |
| | Clifford algebra. |
| eᵢ∧eⱼ | Wedge (outer) product of basis vectors eᵢ and eⱼ. |
| eᵢ · eⱼ = <e₁, eⱼ> | Inner product of basis vectors eᵢ and eⱼ. |
| e₁e₂, e₃e₁, | Basis bivectors of the vector space of the Clifford |
| e₂e₃ | algebra. |
| e₁e₂e₃ | Basis trivector of the vector space of the Clifford |
| | algebra. |
| i₂ = e₁e₂ | Pseudoscalar for Clifford algebras of grade 2. |
| i₃ = e₁e₂e₃ | Pseudoscalar for Clifford algebras of grade 3. |
| x | Euclidean vector in Rⁿ. |
| x∧y | wedge (outer) product of Euclidean vectors x and y. |
| x · y = <x, y> | Inner product of vectors x and y. |
| a | Multivector. |
| ab | Geometric product of multivectors a and b. |
| î, ĵ, \hat{k} | Base elements of quaternions. |

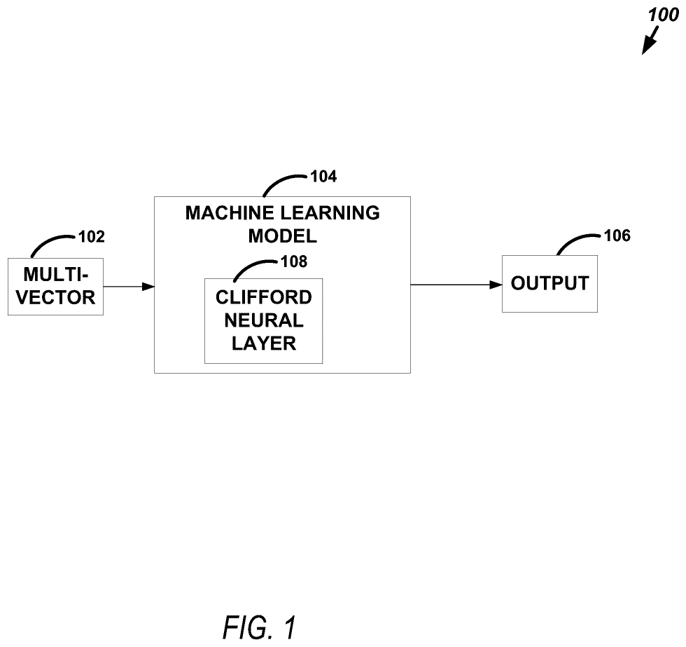

FIG. 1 illustrates, by way of example, a diagram of an embodiment of an ML system 100 for operating on a multivector object input 102. The ML system 100 as illustrated includes an ML model 104 that receives and operates on the multivector object input 102. The ML model 104 operates on the multivector object input 102 using one or more Clifford neural layers 108 to generate an output 106. The output 106 is a representation of a state of a system, being modeled by the ML model 104, responsive to a stimulus represented by the multivector object input 102.

The multivector object input 102 includes a combination of entries comprising two or more of a scalar, vector, bi-vector, tri-vector, or other pseudo scalar. That is, the entries of the multivector object input 102 include two or more of a scalar, vector, bi-vector, tri-vector, or other higher-dimensional vector.

The ML model 104 models a system, such as a physical system, that includes a stimulus represented by the multivector object input 102. Examples of such physical systems includes that include 3D electromagnetic fields, dynamic fluids, and weather forecasting, among many others. The ML model 104 includes the Clifford neural layer 108 that operates on the input 102. The Clifford neural layer 108 can include a Clifford convolution layer, a Clifford Fourier layer, a Clifford equivariant layer, or a combination thereof, such as a Clifford Fourier Neural Operator (FNO) that includes a Clifford convolution layer and a Clifford Fourier layer. The Clifford neural layer 108 operates using a Clifford algebra on the multivector input 102. The output 106 is based on a result of the operations performed by the Clifford neural layer 108. More details on each of these layers can be found in the Appendix.

The output 106 can include a scalar, classification, a multivector object, a vector, a combination thereof, or the like. The output 106, in general, represents the state of the system being modeled by the ML model 104 responsive to the input 102.

Clifford algebras are at the core intersection of geometry and algebra, introduced to simplify spatial and geometrical relations between many mathematical concepts. For example, Clifford algebras naturally unify real numbers, vectors, complex numbers, quaternions, exterior algebras, and many more. Most notably, in contrast to standard vector analysis where primitives are scalars and vectors, Clifford algebras have additional spatial primitives for representing plane and volume segments. An expository example is the cross-product of two vectors in 3 dimensions, which naturally translates to a plane segment spanned by these two vectors. The cross product is often represented as a vector because it has three independent components but has a sign flip under reflection that a true vector does not. In Clifford algebras, different spatial primitives can be summarized into objects called multivectors.

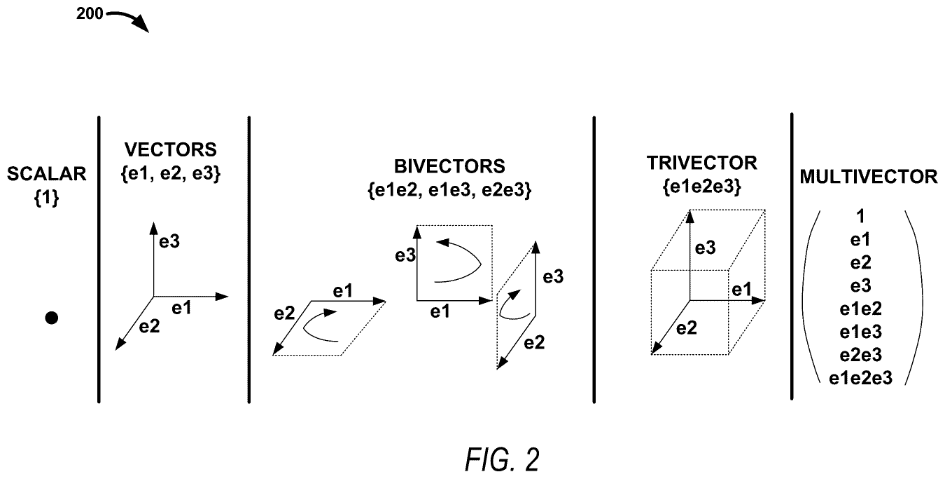

FIG. 2 illustrates, by way of example, a diagram of the spatial primitives of the multivector object and an example multivector object. As illustrated in FIG. 2, the spatial primitives include a scalar, which is a one-dimensional primitive, a vector, which is a point with a direction, a bivector, which is a combination of two vectors, and a trivector, which is a combination of three vectors. There are higher-dimensional primitives. The vector is a multivector of grade 1, the bivector is a multivector of grade 2, etc. and there are multivectors of grade 4, and so on. The multivector includes respective entries corresponding to each of the scalar, vector, bivector, and trivector. Note that a given entry can be zero if the corresponding primitive is not present. The multivector

In embodiments, operations over feature fields in DL architectures are replaced by their Clifford algebra counterparts, which operate on multivector feature fields. For example, a convolutional kernel is endowed with multivector components, such that the kernel can convolve over multivector feature maps. Introducing Clifford neural layers yields at least two advantages: (i) scalar and vector components can be naturally grouped together into a single multivector object, with operations on, and mappings between multivectors defined by Clifford algebras; and (ii) higher order geometric information such as bivectors and trivectors arise, which match aforementioned higher order objects. For example, the curl of a vector field can be described via bivectors, and thus it is beneficial to have bivector filter components to match those.

Embodiments, more specifically, define Clifford convolution and Clifford Fourier transforms over multivector fields, building on connections between Clifford algebras, complex numbers, and quaternions. Based on these definitions, Clifford layers were implemented for different Clifford algebras, replacing convolution and Fourier operations in DL architectures. An evaluation of the effect of using Clifford based architectures on 2-dimensional problems of fluid mechanics and weather modeling, as well as on the 3-dimensional Maxwell's equations is provided to demonstrate that Clifford neural layers consistently improve generalization capabilities of the tested architectures.

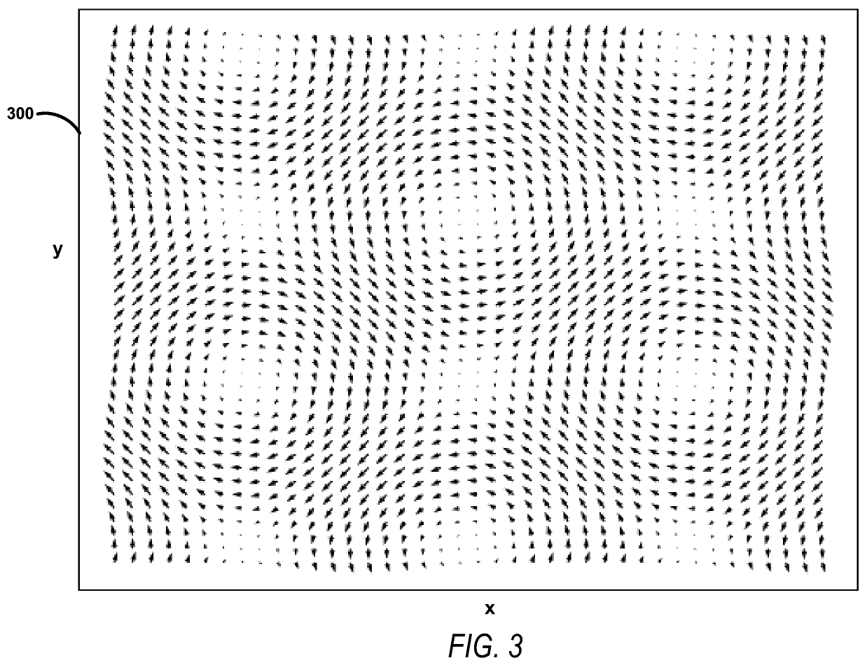

FIGS. 3-5 illustrate, by way of example, respective vector fields that help explain differences between prior treatment of fields and treatment of fields using multivector objects. FIG. 3 illustrates a first vector field 300 that represents some physical phenomena. The vector field 300 includes a plurality of sinks and sources. A sink is a point to which vectors tend to settle (a point towards which vectors point). A sink is considered a point of stability. A source is a point from which vectors tend to point away or “originate” from. A source is considered a point of instability. In FIG. 3 there is a batch size of 1, there are two channels (x and y), and there are 32 samples of each of x and y in the batch.

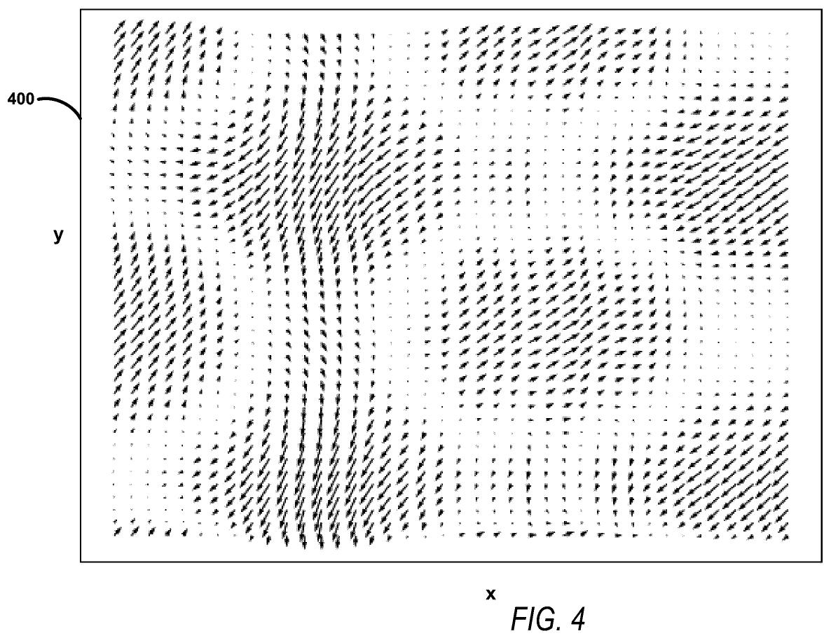

FIG. 4 illustrates, by way of example, a vector field 400 generated by decomposing the vector field 300 into respective x and y Fourier transforms and then attempting to reconstruct the vector field 300 from the Fourier transforms. As can be seen, most, if not all, of the point source and sink structure from the vector field 300 has been lost in the vector field 400. In FIG. 4 there is a batch size of 1, there are two channels (x and y), and there are 32 samples of each of x and y in the batch.

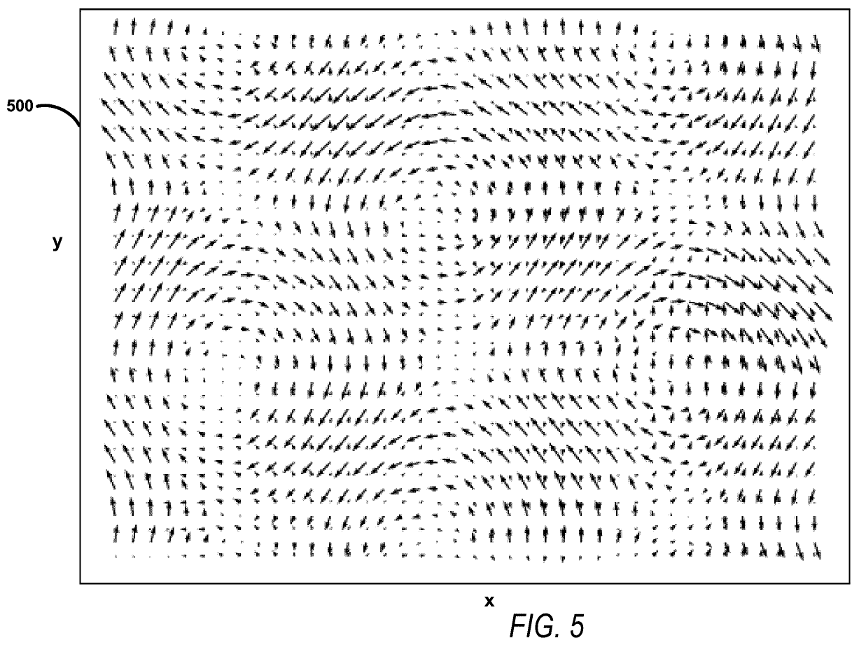

FIG. 5 illustrates, by way of example, a vector field 500 generated by treating the vectors field 300 as a multivector object, performing a Clifford Fourier transform, using a Clifford Fourier layer, on the multivector object, and then reconstructing the vector field 300 from the Clifford Fourier transform. As can be seen, most, if not all, of the point source and sink structure from the vector field 300 has been retained in the vector field 500. In FIG. 5 there is a batch size of 1, there is a single, complex valued channel, and there are 32 samples of each of the single channel in the batch. The Fourier transform is taken over the single channel instead of multiple channels as is typically done.

The channel reduction is a way that the Clifford neural layers of embodiments provide improvements. The channel reduction simplifies the processing and retains more structure than breaking the problems into more channels, operating on the channels individually, and then recombining the outputs of the operations on the channels individually.

A reason the vector field 400 did not retain the structure is because the x and y components were treated independently, and the correlation between the x and y components is ignored or assumed to be negligible. But, in the vector field 500, the correlation between the x and y components is retained by treating the vector field as a multivector object.

What follows is a description of Clifford algebras that form the foundation for treating vector fields as multivector objects.

We introduce important mathematical concepts and discuss three prominent Clifford algebras, Cl_{2,0}(R), Cl_{0,2}(R), Cl_{3,0}(R), which are directly related to the Clifford neural layers. A more detailed introduction as well as connections to complex numbers and quaternions is provided elsewhere. Consider the vector space Rⁿ with standard Euclidean product <., .>, where n=p+q, and p and q are non-negative integers. A real Clifford algebra Cl_{p,q}(R) is an associative algebra generated by p+q orthonormal basis elements e₁, . . . , e_{p+q} of the generating vector space Rⁿ, such that the following quadratic relations hold:

e²=+1 for 1≤i≤p, (1)

e²=−1 for p<j≤p+q, (2)

eᵢeⱼ=−eⱼeᵢ for i=j. (3)

The pair (p, q) is called the signature and defines a Clifford algebra Cl_{p,q}(R), together with the basis elements that span the vector space G^{p+q} of Cl_{p,q}(R). Vector spaces of Clifford algebras have scalar elements and vector elements but can also have elements consisting of multiple basis elements of the generating vector space Rⁿ, which can be interpreted as plane and volume segments. Exemplary low-dimensional Clifford algebras are: (i) Cl_{0,0}(R) which is a one-dimensional algebra that is spanned by the basis element {1} and is therefore isomorphic to R, the field of real numbers; (ii) Cl_{0,1}(R) which is a two-dimensional algebra with vector space G¹ spanned by {1, e₁} where the basis vector e₁ squares to 1, and is therefore isomorphic to C, the field of complex numbers; (iii) Cl_{0,2}(R) which is a 4-dimensional algebra with vector space G² spanned by {1, e₁, e₂, e₁e₂}, where {e₁, e₂ , e₁e₂}all square to 1 and anti-commute. Thus, Cl_{0,2}(R) is isomorphic to the quaternions H.

The grade of a Clifford algebra basis element is the dimension of the subspace it represents. For example, the basis elements {1, e₁, e₂, e₁e₂} of the vector space G² of the Clifford algebra Cl_{0,2}(R) have the grades {0, 1, 1, 2}. Using the concept of grades, one can divide Clifford algebras into linear subspaces made up of elements of each grade. The grade subspace of smallest dimension is M₀, the subspace of all scalars (elements with 0 basis vectors of the generating vector space). Elements of M₁ are called vectors, elements of M₂ are bivectors, and so on. In general, a vector space G^{p+q} of a Clifford algebra Cl_{p,q}(R) can be written as the direct sum of all of these subspaces: G^{p+q}=M₀⊕M₁⊕ . . . ⊕M_{p+q}. The elements of a Clifford algebra are called multivectors, containing elements of subspaces, i.e. scalars, vectors, bivectors, . . . , k-vectors. The basis element with the highest grade is called the pseudoscalar, which in R² corresponds to the bivector e₁e₂, and in R³ to the trivector e₁e₂e₃.

The dual a* of a multivector a is defined as a*=ai_{p+q}, where i_{p+q} represents the respective pseudoscalar of the Clifford algebra. This definition allows one to relate different multivectors to each other, which is a useful property when defining Clifford Fourier transforms. For example, for Clifford algebras in R² the dual of the scalar is the bivector, and in R³, the dual of the scalar is the trivector.

The geometric product is a bilinear operation on multivectors. For arbitrary multivectors a, b, c∈G^{p+q}, and scalar λ, the geometric product has the following properties: (i) closure, i.e. ab G^{p+q}, (ii) associativity, i.e. (ab)c=a(bc); (iii) commutative scalar multiplication, i.e. λR=aλ; (iv) distributive over addition, i.e. a(b+c)=ab+ac. The geometric product is in general non-commutative, i.e. ab≠ba. Note that Equations 1, 2, and 3 describe the geometric product specifically between basis elements of the generating vector space.

Clifford algebras Cl_{2,0}(R) and Cl_{0,2}(R) are now discussed. The 4-dimensional vector spaces of these Clifford algebras have the basis vectors {1, e₁, e₂, e₁e₂} where e₁, e₂, e₁e₂ square to +1 for Cl_{2,0}(R) and to −1 for Cl_{0,2}(R). For Cl_{2,0}(R), the geometric product of two multivectors a=a₀+a₁e₁+a₂e₂+a₁₂e₁e₂ and b=b₀+b₁e₁+b₂e₂+b₁₂e₁e₂ is given by:

ab=(a₀b₀+a₁b₁+a₂b₂−a₁₂b₁₂)1+(a₀b₁+a₁b₀−a₂b₁₂+a₁₂b₂)e₁+(a₀b₂+a₁b₁₂+a₂b₀−a₁₂b₁)e₂+(a₀b₁₂+a₁b₂−a₂b₁+a₁₂b₀)e₁e₂ (4)

which can be derived by collecting terms that multiply the same basis elements. A vector x=(x₁, x₂)∈R² with standard Euclidean product <., .< can be related to x₁e₁+x₂e₂∈R²⊂G². Clifford multiplication of two vectors x, y∈R²⊂G² yields the geometric product xy:

xy=(x₁e₁+x₂e₂)(y₁e₁+y₂e₂)=x₁y₁e₁²+x₂y₂e₂²+x₁y₂e₁e₂+x₂y₁e₂e₁= [symbol] x,y [symbol] +x∧y, (5)

where ∧ is the exterior or wedge product. The asymmetric quantity x∧y=y∧x is associated with the bivector, which can be interpreted as an oriented plane segment.

A unit bivector i₂, spanned by the (orthonormal) basis vectors e₁ and e₂ is determined by the product:

$${i}_{2} = {e}_{1} {e}_{2} = {\underbrace{〈 {e}_{1} , {e}_{2} 〉}}_{= 0} + {e}_{1} ⋀ {e}_{2} = - {e}_{2} ⋀ {e}_{1} = - {e}_{2} {e}_{1} , \qquad ( 6 )$$

which if squared yields i₂²=−1. Thus, i₂ represents a geometric \sqrt{−1}. From Equation 6, it follows that e₂=e₁i₂=−i₂e₁ and e₁=i₂e₂−e₂i₂.

Using the pseudoscalar i₂, the dual of a scalar is a bivector and the dual of a vector is again a vector. The dual pairs of the base vectors are 1↔e₁e₂ and e₁↔e₂. These dual pairs allow one to represent an arbitrary multivector a as

$$a = {a}_{0} + {a}_{1} {e}_{1} + {a}_{2} {e}_{2} + {a}_{12} {e}_{1} {e}_{2} = {\underbrace{( {a}_{0} + {a}_{12} {i}_{2} )} +}_{spinor part} {e}_{1} {\underbrace{( {a}_{1} + {a}_{2} {i}_{2} )}}_{vector part}$$

which can be regarded as two complex-valued parts: the spinor part, which commutes with the base element 1, i.e. 1i₂=i₂1, and the vector part, which anti-commutes with the respective base element e₁, i.e. e₁i₂=e₁e₁e₂=−e₁e₂e₁=−i₂e₁. This decomposition will be the basis for Clifford Fourier transform layers which naturally act on dual pairs.

The Clifford algebra Cl_{0,2}(R) is isomorphic to the quaternions H, which are an extension of complex numbers and are commonly written in the literature as a+bî+cĵ+d\hat{k}. Quaternions also form a 4-dimensional algebra spanned by {1, î, ĵ, \hat{k}}, where î, ĵ, \hat{k} all square to −1. The algebra isomorphism to Cl_{0,2}(R) is easy to verify since e₁, e₂, e₁e₂all square to −1 and anti-commute. The basis element 1 is often called the scalar part, and the basis elements î, ĵ, \hat{k} are called the vector part of a quaternion. Quaternions have practical uses in applied mathematics, particularly for calculations involving three-dimensional rotations, which is used to define the rotational Clifford convolution layer elsewhere.

Clifford algebra Cl_{3,0}(R) is now discussed. The 8-dimensional vector space G³ of the Clifford algebra Cl_{3,0}(R) has the basis vectors {1, e₁, e₂, e₃, e₁e₂, e₃e₁, e₂e₃, e₁e₂e₃}, i.e. it consists of one scalar, three vectors {e₁, e₂, e₃}, three bivectors {e₁e₂, e₃e₁, e₂e₃}, and one trivector e₁e₂e₃. The trivector is the pseudoscalar i₃ of the algebra. The geometric product of two multivectors is defined analogously to the geometric product of Cl_{2,0}(R). The dual pairs of Cl_{3,0}(R) are: 1↔e₁e₂e₃=i₃, e₁↔e₁e₂, e₂↔e₃e₁, and e₃↔e₁e₂.

An intriguing example of the duality of the multivectors of Cl_{3,0}(R) emerges when writing the expression of the electromagnetic field F in terms of an electric vector field E and a magnetic vector field B, such that F=E+B₃, where E=Eₓe₁+E_{y}e₂+E_{z}e₃ and B=Bₓe₁+B_{y}e₂+B_{z}e₃. In this way the electromagnetic field F decomposes into electric vector and magnetic bivector parts via the pseudoscalar i₃. For example, for the base component Bₓe₁ of B it holds that Bₓe₁i₃=Bₓe₁e₁e₂e₃=Bₓe₂e₃ which is a bivector and the dual to the base component Eₓe₁ of E. Consequently, the multivector representing F consists of three vectors (the electric field components) and three bivectors (the magnetic field components multiplied by i₃). This viewpoint gives Clifford neural layers a natural advantage over their corresponding scalar DL counterparts.

Clifford convolution layers and Clifford Fourier transform layers for 2-dimensional problems are now described. Extensions to 3 dimensions are provided elsewhere, along with discussions about appropriate normalization and initialization procedures.

From regular to Clifford CNN layers. Regular convolutional neural network (CNN) layers take as input feature maps ƒ: Z²→R^{c}in and convolve them with a set of cₒᵤₜ filters

$${\{ {w}^{i} \}}_{i = 1}^{{c}_{out}} with {w}^{i} : {Z}^{2} \to {R}^{C} in . : [ f ★ {w}_{i} ] ( x ) = {\sum }_{y ∈ {Z}^{2}} < f ( y ) , \qquad ( 8 )$$

$${w}^{i} ( y - x ) > = {\sum }_{y ∈ {Z}^{2}} {\sum }_{j = 1}^{{c}_{i n}} {f}^{j} ( y ) {w}^{i , j} ( y - x ) .$$

Equation 8 can be interpreted as an inner product of input feature maps with the corresponding filters at every point y∈Z². By applying cₒᵤₜ filters, the output feature maps can be interpreted as cₒᵤₜ dimensional feature vectors at every point y∈Z². It is desired to extend convolution layers such that the element-wise product of scalars ƒ^{j}(y)w^{i,j}(y−x) is replaced by the geometric product of multivector inputs and multivector filters ƒ^{j}(y)w^{i,j}(y−x). Therefore, the feature maps ƒ: Z²→R^{c}in are replaced by multivector feature maps ƒ: Z²→(G²)^{c}in and convolved with a set of cₒᵤₜ multivector filters {wⁱ}ᵢ₌₁^{c}^{ₒᵤₜ}: Z²→(G²)^{c}in:

$$[ f ★ {w}_{i} ] ( x ) = {\underbrace{{\sum }_{y ∈ {Z}^{2}} {\sum }_{j = 1}^{{c}_{in}} {f}^{j} ( y ) {w}^{i , j} ( y - x )}}_{{f}^{j} {w}^{i , j} : {G}^{2} \times {G}^{2} \to {G}^{2}} \qquad ( 9 )$$

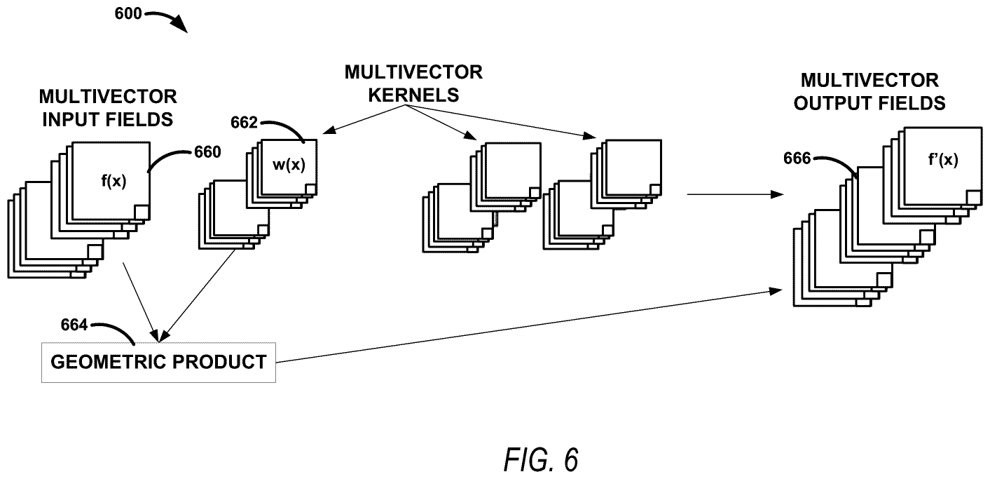

Note that each (geometric) product, indexed by i∈{1, . . . , cₒᵤₜ} and j∈{1, . . . cᵢₙ}, now results in a new multivector rather than a scalar. Hence, the output of a layer is a grid of coat multivectors. One can implement a 2D Clifford CNN layer using Equation 4 where {b₀, b₁, b₂, b₁₂, }→{w₀^{i,j}, w₁^{i,j}, w₂^{i,j}, w₁₂^{i,j}} correspond to 4 different kernels representing one 2D multivector kernel, i.e. 4 different convolution layers, and {a₀, a₁, a₂, a₁₂}→{ƒ₀^{j}, ƒ₁^{j}, ƒ₂^{j}, ƒ₁₂^{j}} correspond to the scalar, vector and bivector parts of the input multivector field. The channels of the different layers represent different stacks of scalars, vectors, and bivectors. Analogously, one can implement a 3D Clifford CNN layer using Equation 45. A schematic sketch of a Clifford convolution layer is shown in FIG. 6.

FIG. 6 illustrates, by way of example, a diagram of an embodiment of a Clifford neural layer 600. The Clifford neural layer 600 convolves a multivector input 660 with multivector kernels 662. The convolution can be performed using the geometric product 664. The result is an output that includes multivector output fields 666. The geometric product 664 is described elsewhere. For a standard convolution implementation consistent with a convolution of FIG. 6, there would be 8 individual channels, and 32 samples for each channel. In FIG. 6 in contrast, there are only two channels, each with four entry inputs (e.g., scalar, vector, bi-vector, etc. parts of the multivector). A geometric product multiplies the multivector kernel to the entries maintaining dependencies on entries of the multivector inputs.

What follows is pseudocode for a 2D Clifford kernel and a Clifford Convolution layer:

```
Function CLIFFORDKERNEL2D(W)
  $KERNEL ← [ \begin{matrix}W [ 0 ] & W [ 1 ] & W [ 2 ] & - W [ 3 ] \\ W [ 1 ] & W [ 0 ] & - W [ 3 ] & W [ 2 ] \\ W [ 2 ] & W [ 3 ] & W [ 0 ] & - W [ 1 ] \\ W [ 3 ] & W [ 2 ] & - W [ 1 ] & W [ 0 ]\end{matrix} ]$
return KERNEL
Function CLIFFORDCONV2D(W, x)
  KERNEL ← CLIFFORDKERNEL2D(W)
  Input ← VIEW_AS_REALVECTOR(x)
  Output ← CLIFFORDCONV(KERNEL, Input)
return VIEW_AS_MULTIVECTOR (Output)
```

An alternative parameterization to the Clifford CNN layer introduced in Equation 9, is called a rotational Clifford CNN layer, and can be realized by using the isomorphism of the Clifford algebra Cl_{0,2}(R) to quaternions. Note that a quaternion rotation can be realized by a matrix multiplication. Using the isomorphism, one can represent the feature maps ƒ^{j} and filters w^{i,j} as quaternions: ƒ^{j}=ƒ₀^{j}+ƒ₁^{j}î+ƒ₂^{j}ĵ+ƒ₃^{j}\hat{k} and w^{i,j}=w₀^{i,j}+w₁^{i,j}ĵ+w₂^{i,j}ĵ+w₃^{i,j}î. One can now devise an alternative parameterization of the product between the feature map ƒ^{j} and w^{i,j}. To be more precise, consider a composite operation that results in a scalar quantity and a quaternion rotation, where the latter acts on the vector part of the quaternion ƒ^{j} and only produces nonzero expansion coefficients for the vector part of the quaternion output. A quaternion rotation w^{i,j}ƒ^{j}(w^{i,j})⁻¹ acts on the vector part (î, ĵ, \hat{k}) of ƒ^{j} and can be algebraically manipulated into a vector matrix operation R^{i,j}ƒ^{j}, where R^{i,j}: H→H is built up from the elements of w^{i,j}. In other words, one can transform the vector part (î, ĵ, \hat{k}) of ƒ^{j}∈H via a rotation matrix R^{i,j} that is built from the scalar and vector part (1, î, ĵ, \hat{k}) of w^{i,j}∈H. Altogether, a rotational multivector filter {wᵣₒₜⁱ}ᵢ₌₁^{c}^{ₒᵤₜ}: Z²→(G²)^{c}^{ᵢₙ} acts on the feature map ƒ^{j} through a rotational transformation R^{i,j}(w_{rot,0}^{i,j}, w_{rot,1}^{i,j}, w_{rot,2}^{i,j}, w_{rot,12}^{i,j}) acting on vector and bivector parts of the multivector feature map ƒ: Z²
(G²)^{c}in, and an additional scalar response of the multivector filters:

$$[ f ★ {w}_{rot}^{i} ] ( x ) = {\sum }_{y ∈ {Z}^{2}} {\sum }_{j = 1}^{{c}_{in}} {\underbrace{{[ {f}^{j} ( y ) {w}_{rot}^{i , j} ( y - x ) ) ]}_{0}}}_{scalar output} + {R}^{i , j} ( y - x ) \cdot ( \begin{matrix}{f}_{1}^{j} ( y ) \\ {f}_{2}^{j} ( y ) \\ {f}_{12}^{j} ( y )\end{matrix} ) \qquad ( 10 )$$

$${Where [ {f}^{j} ( y ) {w}_{rot}^{i , j} ( y - x ) ) ]}_{0} = {f}_{0}^{j} {w}_{rot , 0}^{i , j} - {f}_{1}^{j} {w}_{rot , 1}^{i , j} - {f}_{2}^{j} {w}_{rot , 2}^{i , j} - {f}_{12}^{j} {w}_{rot , 12}^{i , j}$$

is the scalar output of Equation 4.

A detailed description of the rotational multivector filters R^{i,j}(y x) is outlined elsewhere. While in principle the Clifford CNN layer in Equation 9 and the rotational Clifford CNN layer in Equation 10 are equally flexible, the experiments described below show that rotational Clifford CNN layers lead to better performance.

What follows is pseudocode for a 2D Rotational Clifford kernel and a Rotational Clifford Convolution layer:

layer:

```
Function CLIFFORDKERNEL 2 D_{ROT}(W)
  Sq₁₂ < W [1]² + W [2]²
  Sq₁₃ < W [1]² + W [3]²
  Sq₂₃ < W [2]² + W [3]²
  sumsq < W [0]² + W [1]² + W [2]² + W [3]² + ϵ
  rot₁₂ ← W [0]W [1]/sumsq
  rot₁₃ ← W [0]W [2]/sumsq
  rot₁₄ ← W [0]W [3]/sumsq
  rot₂₃ ← W [1]W [2]/sumsq
  rot₂₄ ← W [1]W [3]/sumsq
  rot₃₄ ← W [2]W [3]/sumsq
$KERNEL ← [ \begin{matrix}W [ 0 ] & - W [ 1 ] & - W [ 2 ] & - W [ 3 ] \\ W [ 5 ] & W [ 4 ] ( 1 - s {q}_{23} ) & W [ 4 ] ( {rot}_{23} - & W [ 4 ] ( {rot}_{24} + \\ & & {rot}_{14} ) & {rot}_{13} ) \\ W [ 5 ] & W [ 4 ] ( {rot}_{23} + & W [ 4 ] ( 1 - s {q}_{13} ) & W [ 4 ] ( {rot}_{34} - \\ & {rot}_{14} ) & & {rot}_{12} ) \\ W [ 5 ] & W [ 4 ] ( {rot}_{24} - & W [ 4 ] ( {rot}_{34} + & W [ 4 ] ( 1 - \\ & {rot}_{13} ) & {rot}_{12} ) & {sq}_{12} )\end{matrix} ]$
return KERNEL
Function CLIFFORDCONV2D_{ROT}(W, x)
  KERNEL ← CLIFFORDKERNEL2D_{ROT}(W)
  Input ← VIEW_AS_REALVECTOR(x)
  Output ← CLIFFORDCONV2D(KERNEL, Input)
return VIEW_AS_MULTIVECTOR (Output)
```

Clifford convolutions satisfy the property of equivariance under translation of the multivector inputs. Analogous to a Theorem presented below, translation equivariance can also be shown for rotational Clifford CNN layers. However, the current definition of Clifford convolutions is not equivariant under multivector rotations or reflections. A general kernel constraint for multivector kernels, which sketches a path towards generalized Clifford convolutions which are equivariant w.r.t rotations or reflections is provided below.

From Fourier Neural Operator (FNO) to Clifford Fourier layers. In arbitrary dimension n, the discrete Fourier transform of an n-dimensional complex signal ƒ(x)=ƒ(x₁, . . . , xₙ): Rⁿ→C at M₁× . . . ×Mₙ grid points is defined as:

$$\hat{f} ( {ζ}_{1} , … , {ζ}_{n} ) = ℱ \{ f \} ( {ζ}_{1} , … , {ζ}_{n} ) = {\sum }_{{m}_{1} = 0}^{{M}_{1}} … {\sum }_{{m}_{τ ι} = 0}^{{M}_{τ ι}} f ( {m}_{1} , … , {m}_{n} ) \cdot {e}^{- 2 π i \cdot ( \frac{{m}_{1} {ξ}_{1}}{{M}_{1}} + … + \frac{{m}_{n} {ξ}_{n}}{{M}_{n}} )} , where ( {ξ}_{1} , … , {ξ}_{n} ) ∈ {Z}_{M} 1 … \times … {Z}_{M n} . \qquad ( 11 )$$

In Fourier Neural Operators (FNO), discrete Fourier transforms on real-valued input fields and respective back-transforms — implemented as Fast Fourier Transforms on real-valued inputs (RFFTs) are interleaved with a weight multiplication by a complex weight matrix of shape cᵢₙ×cₒᵤₜ for each mode, which results in a complex-valued weight tensor of the form W∈C^{c}^{ᵢₙ}^{×c}^{ₒᵤₜ}^{×(ξ}^{₁}^{^{max}}^{× . . . ×ξ}^{ₙ}^{^{max}}⁾, where Fourier modes above cut-off frequencies (τ₁^{max}, . . . , τₙ^{max}) are set to zero. Additionally, a residual connection is applied, which is usually implemented as a convolution layer with kernel size 1.

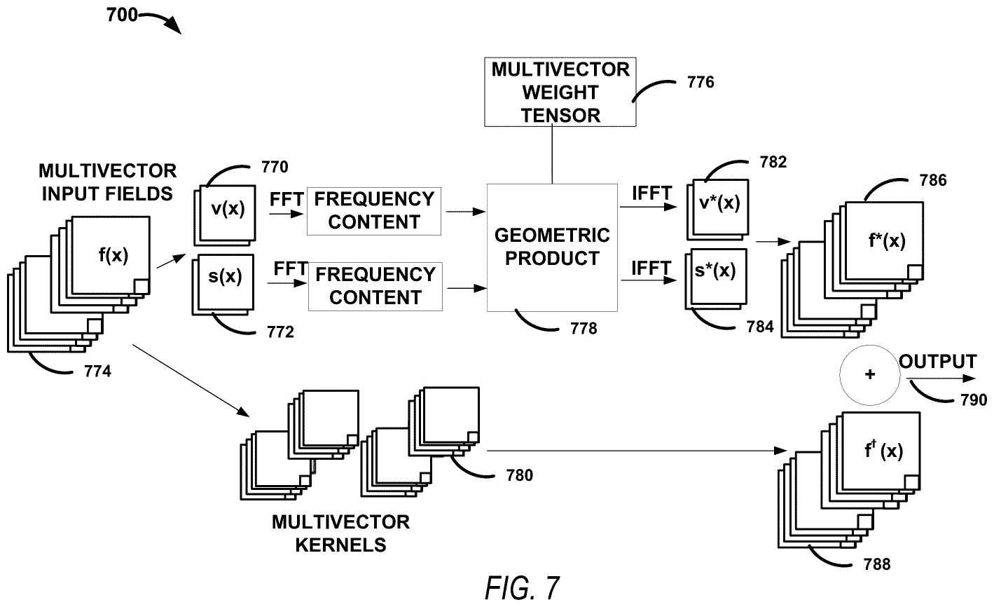

FIG. 7 illustrates, by way of example, a diagram of an embodiment of a Clifford Fourier Neural Operator (CFNO) 700. In the CFNO 700, a real valued Fast Fourier transform (RFFT) over real valued scalar input fields ƒ (x) is replaced by a complex Fast Fourier transform (FFT) over complex valued dual parts v(x) 770 and s(x) 772 of multivector fields ƒ (x) 774. Pointwise multiplication in the Fourier space via complex weight tensor W is replaced by a geometric product 778 in the Clifford Fourier space via multivector weight tensor W 776. Additionally, the convolution path is replaced by Clifford convolutions with multivector kernels 780 w.

For a standard Fourier transform implementation consistent with a convolution of FIG. 7, there would be 8 individual channels, and 32×32 samples for each channel. Thus, 8 individual Fourier transforms would be performed and the results would be combined. In FIG. 7 in contrast, there are only two channels, each with four entry inputs (e.g., scalar, vector, bi-vector, etc. parts of the multivector). Four Fourier transforms are performed, two Fourier transforms per multivector input.

The 2-dimensional Clifford Fourier transform and the respective inverse transform for multivector valued functions ƒ (x): R²→G² and vectors x, ξ∈R² are defined as:

\hat{ƒ}(ξ)= [symbol] {ƒ}(ξ)=½π∫_{R}_{²}ƒ(x)e^{-2πi}^{₂}^{<x,ξ>}dx, ∀ξ∈R², (12)

\hat{ƒ}(ξ)= [symbol] ⁻¹{ [symbol] {ƒ}}(x)=½π∫_{R}_{²}ƒ(ξ)e^{2πi}^{₂}^{<x,ξ>}dξ, ∀x∈R², (13)

provided that the integrals exist. In contrast to standard Fourier transforms, ƒ(x) 774 and \hat{ƒ}(ξ) represent multivector fields in the spatial and the frequency domain, respectively. Furthermore, i₂=e₁e₂ is used in the exponent. Inserting the definition of multivector fields, Equation 12 becomes:

$$ℱ \{ f \} ( ζ ) = 1 / 2 π {\int }_{{R}^{2}} f ( x ) {e}^{- 2 π {i}_{2} 〈 x , ξ 〉} d x = 1 / 2 π {\int }_{{R}^{2}} [ 1 + ( {\underbrace{{f}_{0} ( x ) + {f}_{12} ( x ) {i}_{2}}}_{spinor part} ) + {e}_{1} ( {\underbrace{{f}_{1} ( x ) + {f}_{2} ( x ) {i}_{2}}}_{vector part} ) ] e {- 2 π {i}_{2} 〈 x , ξ 〉}^{} dx = 1 / 2 π {\int }_{{R}^{2}} 1 ( {f}_{0} ( x ) + {f}_{12} ( x ) {i}_{2} ) + {e}_{1} ( {f}_{1} ( x ) + {f}_{2} ( x ) {i}_{2} ) {e}^{- 2 π {i}_{2} 〈 x , ξ 〉} dx = 1 / 2 π {\int }_{{R}^{2}} 1 ( {f}_{0} ( x ) + {f}_{12} ( x ) {i}_{2} ) {e}^{- 2 π {i}_{2} 〈 x , ξ 〉} dx + 1 / 2 π {\int }_{{R}^{2}} {e}_{1} ( {f}_{1} ( x ) + {f}_{2} ( x ) {i}_{2} ) {e}^{- 2 π {i}_{2} < x , ξ >} dx = 1 [ ℱ ( {f}_{0} ( x ) + {f}_{12} ( x ) {i}_{2} ) ( ξ ) ] + {e}_{1} ℱ [ ( {f}_{1} ( x ) + {f}_{2} ( x ) {i}_{2} ) ( ξ ) ] . \qquad ( 14 )$$

A Clifford Fourier transform is obtained by applying two standard Fourier transforms to the dual pairs ƒ₀=ƒ₀(x)+ƒ₁₂(x)i₂ and ƒ₁=ƒ₁(x)+ƒ₂(x)i₂, which both can be treated as a complex-valued signals ƒ₀,ƒ₁: R²→C. Consequently, ƒ(x) 774 can be understood as an element of C². The 2D Clifford Fourier transform is the linear combination of two classical Fourier transforms. Discrete versions of Equation 14 are obtained analogously to Equation 11. Similar to FNO, multivector weight tensors 776 W∈(G²)^{c}^{ᵢₙ}^{×c}^{ₒᵤₜ}^{×(ξ}^{₁}^{^{max}}^{×ξ}^{₂}^{^{max}}⁾ are applied, where again Fourier modes above cut-off frequencies (ξ₁^{max}, ξ₂^{max}) are set to zero. Thus, the Clifford Fourier modes are point-wise modified via the geometric product as follows:

\hat{ƒ}(ξ)= [symbol] {ƒ}(ξ)=\hat{ƒ}₀(ξ)+\hat{ƒ}₁(ξ)e₁+\hat{ƒ}₂(ξ)e₂+\hat{ƒ}₁₂(ξ)e₁₂ (15)

The Clifford Fourier modes follow when combining spinor and vector parts of Equation 14. Finally, the residual connection of a prior FNO is replaced by a Clifford convolution with multivector kernel 780 k, such as by a Cl_{2,0}(R) convolution layer 600. A schematic sketch of a Clifford Fourier layer is shown in FIG. 7. 3D Clifford Fourier transforms follow a similar elegant construction, where four separate Fourier transforms to the complex fields as in Equation 16:

ƒ₀(x)=ƒ₀(x)+ƒ₁₂₃(x)i₃, ƒ₁(x)=ƒ₁(x)+ƒ₂₃(x)i₃

ƒ₂(x)=ƒ₂(x)+ƒ₃₁(x)i₃, ƒ₃(x)=ƒ₃(x)+ƒ₁₃(x)i₃

In Equation 16 scalar/trivector and vector/bivector components are combined into complex fields and then subjected to a Fourier transform. More details on 2D and 3D Fourier transforms and their properties can be found elsewhere. Spatial representations of v(x) 770 and s(x) 772 are recovered by an inverse FFT which provides v*(x) 782 and s*(x) 784 that are combined to form ƒ*(x) 786. A result 788 of the Clifford convolution is combined with ƒ*(x) 786 to from an output 790 of the Clifford FNO 700.

What follows is pseudocode for implementing a Clifford Spectral Convolution and a Clifford Fourier Layer:

```
Function CLIFFORDSPECTRALCONV2D(W, x, m₁, m₂)
xᵥ, xₛ ← VIEW_AS_DUAL_PARTS(x)
f(xᵥ) ← FFT2(xᵥ) - Complex 2D FFT of vector part
f(xₛ) ← FFT2(xₛ) - Complex 2D FFT of scalar part
$\begin{matrix}{f}^{*} ( {x}_{v} ) ← [ \begin{matrix}f ( {x}_{v} ) [ … , : {m}_{1} , : {m}_{2} ] & f ( {x}_{v} ) [ … , : {m}_{1} , - {m}_{2} : ] \\ f ( {x}_{v} ) [ … , - {m}_{1} : {m}_{2} ] & f ( {x}_{v} ) [ … , - {m}_{1} : , - {m}_{2} : ]\end{matrix} ] - \\ Vector modes\end{matrix}$
$\begin{matrix}{f}^{*} ( {x}_{s} ) ← [ \begin{matrix}f ( {x}_{s} ) [ … , : {m}_{1} , : {m}_{2} ] & f ( {x}_{s} ) [ … , : {m}_{1} , - {m}_{2} : ] \\ f ( {x}_{s} ) [ … , - {m}_{1} : , : {m}_{2} ] & f ( {x}_{s} ) [ … , - {m}_{1} : , - {m}_{2} : ]\end{matrix} ] - \\ Scalar modes\end{matrix}$
f*(x) ← f*(xₛ) · r + f*(xᵥ) + f*(xᵥ) · i + f*(xₛ) · i - Multivector
Fourier modes
f*(x) ← f*(x)W - Geometric product in Fourier space
\hat{x}ᵥ ← IFFT2(\hat{f}*(x)[1] + \hat{f}*(x)[2]) - Inverse 2D FFT of vector part
\hat{x}ₛ ← IFFT2(\hat{f}*(x)[0] + \hat{f}*(x)[3]) - Inverse 2D FFT of scalar part
\hat{x} ← VIEW_AS_MULTIVECTOR(\hat{x}ᵥ, \hat{x}ₛ)
return \hat{x}
Function CLIFFORDFOURIERLAYER(W_{f}, W_{c}, x)
  y₁ ← CLIFFORDSPECTRALCONV(W_{f}, x, m₁, m₂)
  x₂ ← VIEW_AS_REALVECTOR(x)
  y₂ ← CLIFFORDCONV(W_{c}, x₂)
  y₂ ← VIEW_AS_MULTIVECTOR(y₂)
  out ← ACTIVATION (y₁ + y₂)
return out
```

An assessment of Clifford neural layers was performed for different architectures in three experimental settings: the incompressible Navier-Stokes equations, shallow water equations for weather modeling, and 3-dimensional Maxwell's equations in matter.

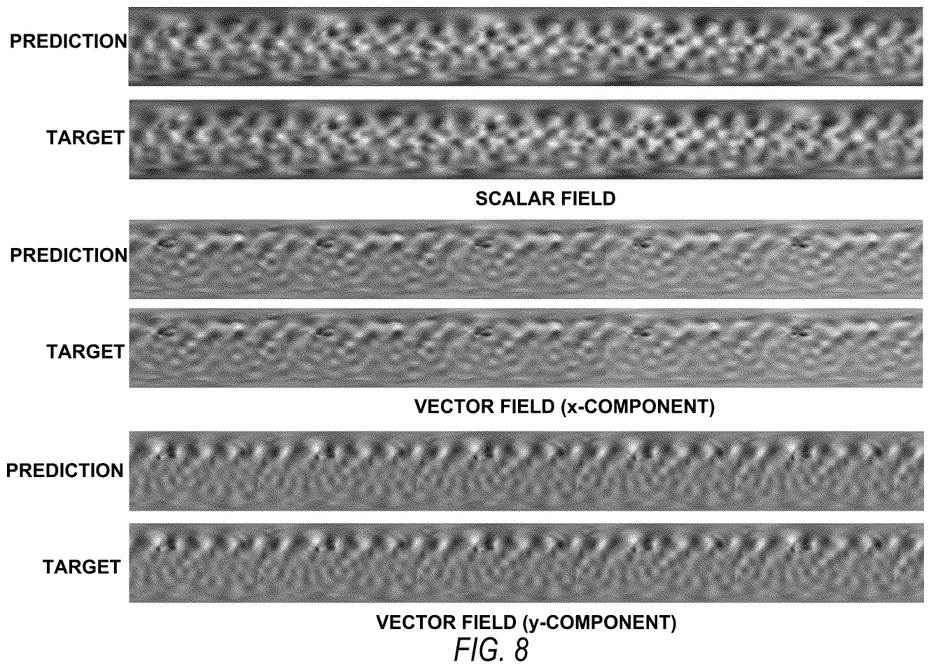

Ablations were also performed for different dataset sizes. All datasets share the common trait of containing multiple input and output fields. More precisely, one scalar and one 2-dimensional vector field in case of the Navier-Stokes and the shallow water equations, and a 3-dimensional (electric) vector field and its dual (magnetic) bivector field in case of the Maxwell's equations. ResNet and Fourier Neural Operator (FNO) based architectures were replaced with their respective Clifford algebra neural layer counterparts. In doing so, every convolution and every Fourier transform was changed to a respective Clifford neural layer operation. Also, a substitution for normalization techniques and activation functions with appropriate counterparts was performed. Different training set sizes were evaluated, and losses for scalar and vector fields are reported. Inputs to the neural PDE surrogates are respective fields at previous t timesteps, where t varies between different PDEs. The one-step loss is the mean-squared error at the next timestep summed over fields. The rollout loss is the mean-squared error after applying the neural PDE surrogate 5 times, summing over fields and time dimension. More information on the datasets, implementation details of the tested architectures, loss functions, and more detailed results can be found elsewhere. FIG. 8 shows example rollouts of the scalar and the vector field components obtained by Clifford Fourier PDE surrogates for a qualitative comparison.

The summed MSE (SMSE) loss used in these experiments are defined as:

L_{SMSE}=1/N_{y}Σ_{y∈Z}_{³} _{or Z}_{²}Σⱼ₌₁^{N}^{ₜ}Σᵢ₌₁^{N}^{_{fields}}∥uᵢ(y,tⱼ)−ûᵢ(y,tⱼ)∥₂²

where u is the target, û the model output, N_{fields} comprises scalar fields as well as individual vector field components, and N_{y} is the total number of spatial points. The L_{SMSE} Equation is used for training with Nₜ=1, and four metrics:
One-step loss where Nₜ=1 and N_{fields} comprises all scalar and vector components.
Vector loss where Nₜ=1 and N_{fields} comp rises only vector components.
Scalar loss where Nₜ=1 and N_{fields} comprises only the scalar field.
Rollout loss where Nₜ=5 and N_{fields} comprises all scalar and vector components.

For Maxwell's equation, electric and magnetic loss are defined analogously to the vector and the scalar loss for Navier-Stokes and shallow water experiments.

Experiments are performed with two architecture families: ResNet models and Fourier Neural Operators (FNOs). All baseline models are fine-tuned for all individual experiments with respect to number of blocks, number of channels, number of modes (FNO), learning rates, normalization and initialization procedures, and activation functions. The best models are reported, and for reported Clifford results each convolution layer is substituted with a Clifford convolution, each Fourier layer with a Clifford Fourier layer, each normalization with a Clifford normalization and each non-linearity with a Clifford non-linearity. A Clifford non-linearity in this context is the application of the corresponding default linearity to the different multivector components.

For Navier-Stokes and shallow water experiments, ResNet architectures with 8 residual blocks, each consisting of two convolution layers with 3 x3 kernels, shortcut connections, group normalization, and Gaussian Error Linear Unit (GeLU) activation functions were used. Two embedding and two output layers were used, i.e. the overall architectures could be classified as Res-20 networks. In contrast to standard residual networks for image classification, down-projection techniques were not used. Down projections are convolution layers with strides larger than 1 or via pooling layers. In contrast, the spatial resolution stays constant throughout the network. The same number of hidden channels throughout the network, that is 128 channels per layer were used. Overall this results in roughly 1.6 million parameters. Increasing the number of residual blocks or the number of channels did not increase the performance significantly.

For every ResNet-based experiment, the fine-tuned ResNet architectures were replaced with two Clifford counterparts: each CNN layer is replaced with a (i) Clifford CNN layer, and (ii) with a rotational Clifford CNN layer. To keep the number of weights similar, instead of 128 channels the resulting architectures have 64 multivector channels, resulting again in roughly 1.6 million floating point parameters. Additionally for both architectures, GeLU activation functions are replaced with Clifford GeLU activation functions, group normalization is replaced with Clifford group normalization. Using Clifford initialization techniques did not improve results.

For Navier-Stokes and shallow water experiments, 2-dimensional Fourier Neural Operators (FNOs) consisting of 8 FNO blocks, two embedding and two output layers were used. Each FNO block comprised a convolution path with a 1×1 kernel and an FFT path. 16 Fourier modes (for x and y components) for point-wise weight multiplication were used, and overall use 128 hidden channels. GeLU activation functions were used. Additional shortcut connections or normalization techniques, such as batchnorm or group were used. Note norm did not improve performance, neither did larger numbers of hidden channels, nor more FNO blocks. Overall this resulted in roughly 140 million parameters for FNO based architectures.

For 3-dimensional Maxwell experiments, 3-dimensional Fourier Neural Operators (FNOs) consisting of 4 FNO blocks, two embedding and two output layers were used. Each FNO block comprised a 3D convolution path with a 1×1 kernel and an FFT path. 6 Fourier modes (for x, y, and z components) for point-wise weight multiplication were used, and overall used 96 hidden channels. Interestingly, using more layers or more Fourier modes degraded performances. Similar to the 2D experiments, GeLU activation functions were used, and did not apply shortcut connections nor normalization techniques, such as batchnorm or groupnorms. Overall this resulted in roughly 65 million floating point parameters for FNO based architectures.

For every FNO-based experiment, the fine-tuned FNO architectures were replaces with respective Clifford counterparts: each FNO layer was replaced by its Clifford counterpart. To keep the number of weights similar, instead of 128 channels the resulting architectures have 48 multivector channels, resulting in roughly the same number of parameters. Additionally, GeLU activation functions are replaced with Clifford GeLU activation functions. Using Clifford initialization techniques did not improve results.

For 3-dimensional Maxwell experiments, each 3D Fourier transform layer was replaced with a 3D Clifford Fourier layer and each 3D convolution with a respective Clifford convolution. 6 Fourier modes (for x, y, and z components) for point-wise weight multiplication were used, and overall used 32 hidden multivector channels, which results in roughly the same number of parameters (55 million). In contrast to 2-dimensional implementations, Clifford initialization techniques proved important for 3-dimensional architectures. Most notably, too large initial values of the weights of Clifford convolution layers hindered gradient flows through the Clifford Fourier operations.

Models were optimized using the Adam optimizer with learning rates [10⁻⁴, 2·10⁻⁴, 5 10⁻⁴] for 50 epochs and minimized the summed mean squared error (SMSE) which is outlined in L_{SMSE} Equation. Cosine annealing was used as a learning rate scheduler with a linear warmup. For baseline ResNet models, the number of layers, number of channels, and normalization procedures were optimized. Different activation functions were tested. For baseline FNO models, number of layers, number of channels, and number of Fourier modes were optimized. Larger numbers of layers or channels did not improve the performances for both ResNet and FNO models. For the respective Clifford counterparts, convolution and Fourier layers were replaced by Clifford convolution and Clifford Fourier layers, respectively. Clifford normalization schemes were used. The number of layers was adjusted to obtain similar numbers of parameters. Clifford architectures could have been optimized slightly more by, for example, using different numbers of hidden layers than the baseline models did. However, this would (i) slightly be against the argument of having “plug- and play” replace layers, and (ii) would have added quite some computational overhead.

All FNO and CFNO experiments used 4×16 GB NVIDIA V100 machines for training All ResNet and Clifford ResNet experiments used 8×32 GB NVIDIA V100 machines. Average training times varied between 3 h and 48 h, depending on task and number of trajectories. Clifford runs on average took twice as long to train for equivalent architectures and epochs.

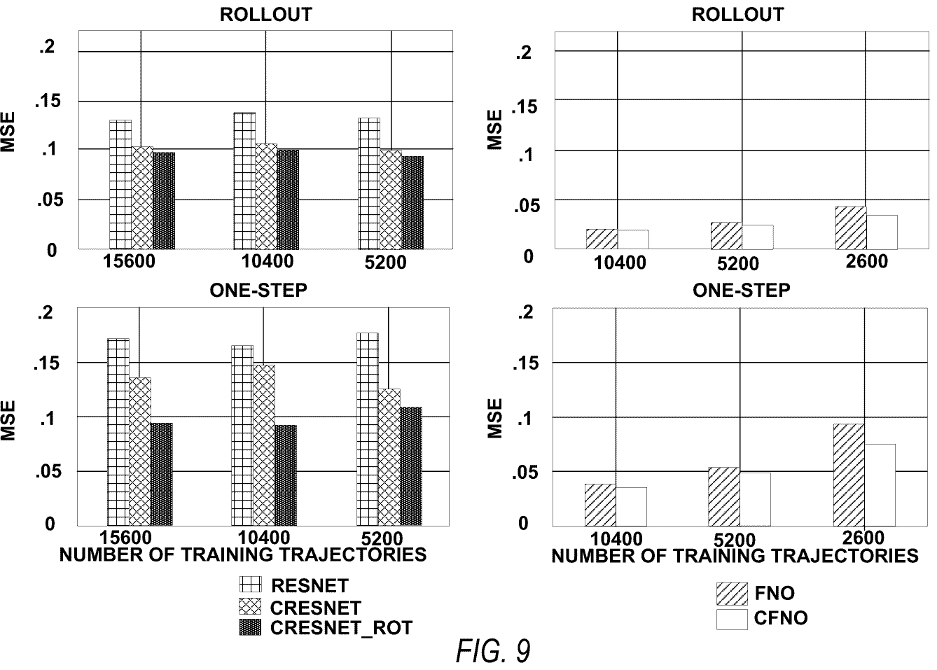

The incompressible Navier-Stokes equations are built upon momentum and mass conservation of fluids expressed for the velocity flow field v:

$$\frac{\partial v}{\partial t} = - v \cdot ∇ v + μ {∇}^{2} v - ∇ p + f , ∇ \cdot v = 0 \qquad ( 17 )$$

where v·∇v is the convection, μ∇²v the viscosity, ∇p the internal pressure and ƒ an external force. In addition to the velocity field v(x), a scalar field s(x) can be introduced that represents a scalar quantity, for example, smoke, that is being transported via the velocity field. The scalar field is advected by the vector field, as the vector field changes, the scalar field is transported along with it, whereas the scalar field influences the vector field only via the external force term ƒ. This is called a weak coupling between vector and scalar fields. The 2D Navier-Stokes equation can be modeled using ΦFlow, obtaining data on a grid with spatial resolution of 128×128 (Δx=0.25, Δy=0.25), and temporal resolution of Δt=1.5 s. Results for one-step loss and rollout loss on the test set are shown in FIG. 9.

Convection is the rate of change of a vector field along a vector field (in this case along itself), viscosity is the diffusion of a vector field, i.e. the net movement form higher valued regions to lower concentration regions, μ is the viscosity coefficient. The incompressibility constrained yields mass conservation via ∇·v=0. For example, v might represent velocity of air inside a room, and s might represent concentration of smoke. Similar to convection, advection is the transport of a scalar field along a vector field

$$\frac{ds}{dt} = - v \cdot Δ s .$$

The 2D Navier-Stokes equation can be implemented using ΦFlow. Solutions are propagated in which one can solve for the pressure field and subtract its spatial gradients afterwards. Semi-Lagrangian advection (convection) is used for v, and McCormack advection for s. Additionally, express the external buoyancy force ƒ in Equation 17 as force acting on the scalar field. Solutions are obtained using Boussinesq approximation, which ignores density differences except where they appear in terms multiplied by the acceleration due to gravity. The essence of the Boussinesq approximation is that the difference in inertia is negligible but gravity is sufficiently strong to make the specific weight appreciably different between the two fluids.

FIG. 9 illustrates, by way of example, graphs of one-step loss and rollout loss for a variety of NN PDE modeling architectures implementing Navier-Stokes equation. For ResNet-like architectures, observe that both CResNet (Clifford ResNet or ResNet with layers replaced with Clifford neural layers) and CResNetrot (rotational Clifford ResNet or ResNet with layers replaced with rotational Clifford neural layers) improve upon the ResNet baseline. Additionally, observe that rollout losses are also lower for the two Clifford based architectures, which can be attributed to better and more stable models that do not overfit to one-step predictions so easily. Lastly, while in principle CResNet and CResNetᵣₒₜ based architectures are equally flexible, CResNetᵣₒₜ in general performs better than CResNet in this scenario. For FNO and respective Clifford Fourier based (CFNO) architectures, the loss is in general much lower than for ResNet based architectures. CFNO architectures improve upon FNO architectures for all dataset sizes, and for one-step as well as rollout losses.

TABLE 1
Model comparison on four different metrics for neural PDE surrogates which
are trained on Navier-Stokes training datasets of varying size. Error bars
are obtained by running experiments with three different initial seeds.

| | | SMSE | | | |
|---|---|---|---|---|---|
| Method | Trajs. | scalar | vector | onestep | rollout |
| ResNet | | 0.00300 ± 0.00003 | 0.01255 ± 0.00008 | 0.01553 ± 0.00011 | 0.11362 ± 0.00048 |
| CResNet | 2080 | 0.00566 ± 0.00062 | 0.02252 ± 0.00284 | 0.02806 ± 0.00346 | 0.15844 ± 0.02677 |
| CResNetᵣₒₜ | | 0.00376 ± 0.00028 | 0.01413 ± 0.00116 | 0.01780 ± 0.00143 | 0.10681 ± 0.00476 |
| ResNet | | 0.00341 ± 0.00028 | 0.01431 ± 0.00102 | 0.01767 ± 0.00138 | 0.13234 ± 0.00020 |
| CResNet | 5200 | 0.00265 ± 0.00004 | 0.00988 ± 0.00024 | 0.01250 ± 0.00022 | 0.09975 ± 0.00060 |
| CResNetᵣₒₜ | | 0.00234 ± 0.00014 | 0.00857 ± 0.00066 | 0.01087 ± 0.00074 | 0.09427 ± 0.00071 |
| ResNet | | 0.00321 ± 0.00004 | 0.01337 ± 0.00044 | 0.01653 ± 0.00048 | 0.13802 ± 0.00223 |
| CResNet | 10400 | 0.00315 ± 0.00006 | 0.01162 ± 0.00019 | 0.01473 ± 0.00018 | 0.10671 ± 0.00246 |
| CResNetᵣₒₜ | | 0.00201 ± 0.00020 | 0.00719 ± 0.00074 | 0.00917 ± 0.00090 | 0.10005 ± 0.00229 |
| ResNet | | 0.00342 ± 0.00003 | 0.01379 ± 0.00079 | 0.01716 ± 0.00091 | 0.13030 ± 0.00379 |
| CResNet | 15600 | 0.00285 ± 0.00019 | 0.01076 ± 0.00051 | 0.01357 ± 0.00063 | 0.10372 ± 0.00269 |
| CResNetᵣₒₜ | | 0.00204 ± 0.00014 | 0.00736 ± 0.00069 | 0.00938 ± 0.00087 | 0.09799 ± 0.00139 |
| FNO | 2080 | 0.00318 ± 0.00021 | 0.00613 ± 0.00044 | 0.00931 ± 0.00064 | 0.04281 ± 0.00300 |
| CFNO | | 0.00266 ± 0.00002 | 0.00484 ± 0.00006 | 0.00749 ± 0.00008 | 0.03461 ± 0.00031 |
| FNO | 5200 | 0.00204 ± 0.00004 | 0.00332 ± 0.00011 | 0.00536 ± 0.00015 | 0.02684 ± 0.00067 |
| CFNO | | 0.00189 ± 0.00001 | 0.00293 ± 0.00002 | 0.00482 ± 0.00003 | 0.02430 ± 0.00012 |
| FNO | 10400 | 0.00156 ± 0.00003 | 0.00220 ± 0.00007 | 0.00375 ± 0.00010 | 0.02005 ± 0.00042 |
| CFNO | | 0.00148 ± 0.00001 | 0.00205 ± 0.00001 | 0.00353 ± 0.00002 | 0.01886 ± 0.00006 |

The shallow water equations describe a thin layer of fluid of constant density in hydrostatic balance, bounded from below by the bottom topography and from above by a free surface. For example, the deep water propagation of a tsunami can be described by the shallow water equations. For simplified weather modeling, the shallow water equations express the velocity in x-direction, or zonal velocity vx, the velocity in the y-direction, or meridional velocity v_{y}, the acceleration due to gravity g, and the vertical displacement of free surface η(x,y), which subsequently is used to derive pressure fields:

$$\frac{\partial {v}_{x}}{\partial t} + {v}_{x} \frac{\partial {v}_{x}}{\partial x} + {v}_{y} \frac{\partial {v}_{x}}{\partial y} + \frac{g \partial η}{\partial x} = 0 \qquad ( 18 )$$

$$\frac{\partial {v}_{y}}{\partial t} + {v}_{x} \frac{\partial {v}_{y}}{\partial x} + {v}_{y} \frac{\partial {v}_{y}}{\partial y} + \frac{g \partial η}{\partial y} = 0$$

$$\frac{\partial η}{\partial t} + \frac{\partial }{\partial x} [ ( η + h ) {v}_{x} ] + \frac{\partial }{\partial y} [ ( η + h ) {v}_{y} ] = 0$$

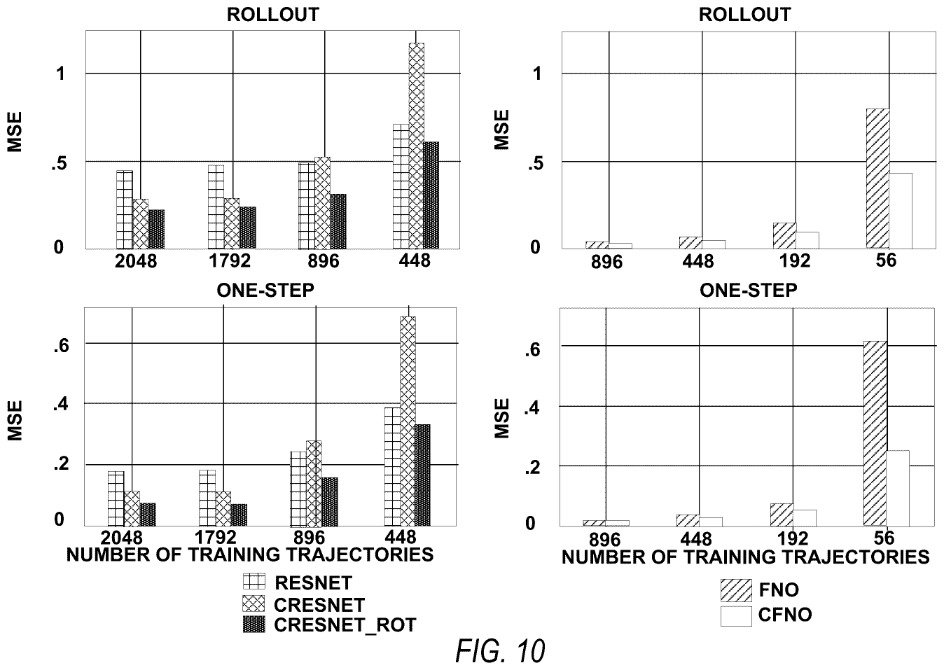

The topography of the earth is modeled by h(x, y). The relation between vector and scalar components is relatively strong (strong coupling between vector and scalar fields due to the 3-coupled PDEs of Equation 18). One can modify the implementation in SpeedyWeather.jl, obtaining data on a grid with spatial resolution of 192×96 (Δx=1.875°, Δy=3.75°), and temporal resolution of Δt=6 h. Results for one-step loss and rollout loss on the test set are shown in FIG. 10. The equation is solved on a closed domain with periodic boundary conditions. The simulation was rolled out for 20 days and sample every 6 h. Here 20 days is of course not the actual simulation time but rather the simulated time. Trajectories contain scalar pressure and wind vector fields at 84 different time points.

SpeedyWeather.jl combines the shallow water equations with spherical harmonics for the linear terms and Gaussian grid for the non-linear terms with the appropriate spectral transforms. It internally uses a leapfrog time scheme with a Robert and William's filter to dampen the computational modes and achieve 3rd order accuracy. SpeedyWeather.jl is based on the atmospheric general circulation model SPEEDY in Fortran.

FIG. 10 illustrates, by way of example, MSE loss for one-step and rollout for various NN architectures implementing Navier-Stokes equations. Observe similar performance properties as for the Navier-Stokes experiments discussed previously. However, performance differences between baseline and Clifford architectures are even more pronounced, which can be attributed to the stronger coupling of the scalar and the vector fields. For ResNet-like architectures, CResNet and CResNetᵣₒₜ improve upon the ResNet baseline, rollout losses are much lower for the two Clifford based architectures, and CResNetᵣₒₜ based architectures in general perform better than CResNet based ones. For Fourier based architectures, the loss is in general much lower than for ResNet based architectures (a training set size of 56 trajectories yields similar (C)FNO test set performance than a training set size of 896 trajectories for ResNet based architectures). CFNO architectures improve upon FNO architectures for all dataset sizes, and for one-step as well as rollout losses, which is especially pronounced for low number of training trajectories.

TABLE 2
Model comparison on four different metrics for neural PDE surrogates which
are trained on the shallow water equations training datasets of varying size.
Results are obtained by using a two timestep history input. Error bars are
obtained by running experiments with three different initial seeds.

| | | SMSE | | | |
|---|---|---|---|---|---|
| Method | Trajs. | scalar | vector | onestep | rollout |
| ResNet | | 0.0240 ± 0.0002 | 0.0421 ± 0.0010 | 0.0661 ± 0.0011 | 1.1195 ± 0.0197 |
| CResNet | 192 | 0.0617 ± 0.0016 | 0.0823 ± 0.0027 | 0.1440 ± 0.0042 | 2.0423 ± 0.0494 |
| CResNetᵣₒₜ | | 0.0319 ± 0.0003 | 0.0576 ± 0.0005 | 0.0894 ± 0.0007 | 1.4756 ± 0.0044 |
| ResNet | | 0.0140 ± 0.0003 | 0.0245 ± 0.0007 | 0.0385 ± 0.0010 | 0.7083 ± 0.0119 |
| CResNet | 448 | 0.0238 ± 0.0007 | 0.0448 ± 0.0023 | 0.0685 ± 0.0030 | 1.1727 ± 0.0483 |
| CResNetᵣₒₜ | | 0.0114 ± 0.0001 | 0.0221 ± 0.0001 | 0.0335 ± 0.0002 | 0.6127 ± 0.0018 |
| ResNet | | 0.0086 ± 0.0000 | 0.0156 ± 0.0003 | 0.0242 ± 0.0003 | 0.4904 ± 0.0080 |
| CResNet | 896 | 0.0095 ± 0.0000 | 0.0183 ± 0.0004 | 0.0278 ± 0.0006 | 0.5247 ± 0.0101 |
| CResNetᵣₒₜ | | 0.0055 ± 0.0000 | 0.0106 ± 0.0001 | 0.0161 ± 0.0001 | 0.3096 ± 0.0010 |
| ResNet | | 0.0061 ± 0.0002 | 0.0123 ± 0.0009 | 0.0184 ± 0.0010 | 0.4780 ± 0.0062 |
| CResNet | 1792 | 0.0039 ± 0.0000 | 0.0071 ± 0.0000 | 0.0111 ± 0.0001 | 0.2842 ± 0.0067 |
| CResNetᵣₒₜ | | 0.0025 ± 0.0000 | 0.0044 ± 0.0000 | 0.0069 ± 0.0000 | 0.2370 ± 0.0000 |
| ResNet | | 0.0060 ± 0.0002 | 0.0121 ± 0.0003 | 0.0181 ± 0.0005 | 0.4480 ± 0.0058 |
| CResNet | 2048 | 0.0039 ± 0.0001 | 0.0072 ± 0.0002 | 0.0111 ± 0.0003 | 0.2816 ± 0.0065 |
| CResNetᵣₒₜ | | 0.0028 ± 0.0005 | 0.0480 ± 0.0006 | 0.0075 ± 0.0011 | 0.2164 ± 0.0070 |
| FNO | 56 | 0.0271 ± 0.0016 | 0.0345 ± 0.0007 | 0.0616 ± 0.0022 | 0.8032 ± 0.0043 |
| CFNO | | 0.0071 ± 0.0003 | 0.0177 ± 0.0004 | 0.0250 ± 0.0007 | 0.4323 ± 0.0046 |
| FNO | 192 | 0.0021 ± 0.0002 | 0.0057 ± 0.0001 | 0.0077 ± 0.0003 | 0.1444 ± 0.0026 |
| CFNO | | 0.0012 ± 0.0000 | 0.0040 ± 0.0001 | 0.0053 ± 0.0001 | 0.0941 ± 0.0021 |
| FNO | 448 | 0.0007 ± 0.0001 | 0.0026 ± 0.0000 | 0.0034 ± 0.0001 | 0.0651 ± 0.0014 |
| CFNO | | 0.0005 ± 0.0000 | 0.0020 ± 0.0000 | 0.0026 ± 0.0001 | 0.0455 ± 0.0009 |
| FNO | 896 | 0.0004 ± 0.0000 | 0.0016 ± 0.0000 | 0.0020 ± 0.0001 | 0.0404 ± 0.0005 |
| CFNO | | 0.0003 ± 0.0000 | 0.0013 ± 0.0000 | 0.0017 ± 0.0001 | 0.0315 ± 0.0004 |

TABLE 3
Model comparison on four different metrics for neural PDE surrogates which
are trained on the shallow water equations training datasets of varying size.
Results are obtained by using a four timestep history input. Error bars are
obtained by running experiments with three different initial seeds.

| | | SMSE | | | |
|---|---|---|---|---|---|
| Method | Trajs. | scalar | vector | onestep | rollout |
| FNO | 56 | 0.0276 ± 0.0017 | 0.0388 ± 0.0023 | 0.0663 ± 0.0038 | 0.6821 ± 0.0379 |
| CFNO | | 0.0093 ± 0.0003 | 0.0252 ± 0.0005 | 0.0345 ± 0.0009 | 0.4357 ± 0.0056 |
| FNO | 192 | 0.0033 ± 0.0007 | 0.0069 ± 0.0009 | 0.0102 ± 0.0015 | 0.1612 ± 0.0057 |
| CFNO | | 0.0015 ± 0.0001 | 0.0050 ± 0.0003 | 0.0065 ± 0.0003 | 0.1023 ± 0.0026 |
| FNO | 448 | 0.0009 ± 0.0001 | 0.0023 ± 0.0002 | 0.0032 ± 0.0003 | 0.0687 ± 0.0023 |
| CFNO | | 0.0010 ± 0.0006 | 0.0039 ± 0.0027 | 0.0050 ± 0.0033 | 0.1156 ± 0.0913 |
| FNO | 896 | 0.0004 ± 0.0001 | 0.0012 ± 0.0001 | 0.0016 ± 0.0001 | 0.0436 ± 0.0011 |
| CFNO | | 0.0003 ± 0.0000 | 0.0012 ± 0.0001 | 0.0015 ± 0.0001 | 0.0353 ± 0.0010 |

Electromagnetic simulations play a critical role in understanding light-matter interaction and designing optical elements. Neural networks have been already successful applied in inverse-designing photonic structures.

Maxwell's equations in matter are:

$$\begin{matrix}∇ \cdot D = ρ & Gauss ' s law \\ ∇ \cdot B = 0 & Gauss ' s law for magnetism \\ ∇ \times E = - \partial B / \partial t & Faraday ' s law of induction \\ ∇ \times H = \frac{\partial D}{\partial t} + j & Ampère ' s circuital law\end{matrix}$$

In isotropic media, Maxwell's equations in matter propagate solutions of the displacement field D, which is related to the electrical field via D=ϵ₀ϵ_{R}E, where ϵ₀ is the permittivity of free space and ϵᵣ is the permittivity of the medium, and the magnetization field H, which is related to the magnetic field B via H=μ₀μₜB, where μ₀ is the permeability of free space and μᵣ is the permeability of the medium. Lastly, j is the electric current density and ρ the total electric charge density.

The electromagnetic field F has the intriguing property that the electric field E and the magnetic field B are dual pairs, thus F=E+Bi₃. There is a strong coupling between the electric field and its dual (bivector) magnetic field. This duality also holds for D and H. The solution of Maxwell's equation in matter can be propagated using a finite-difference time-domain method, where the discretized Maxwell's equations are solved in a leapfrog manner. First, the electric field vector components in a volume of space are solved at a given instant in time. Second, the magnetic field vector components in the same spatial volume are solved at the next instant in time.

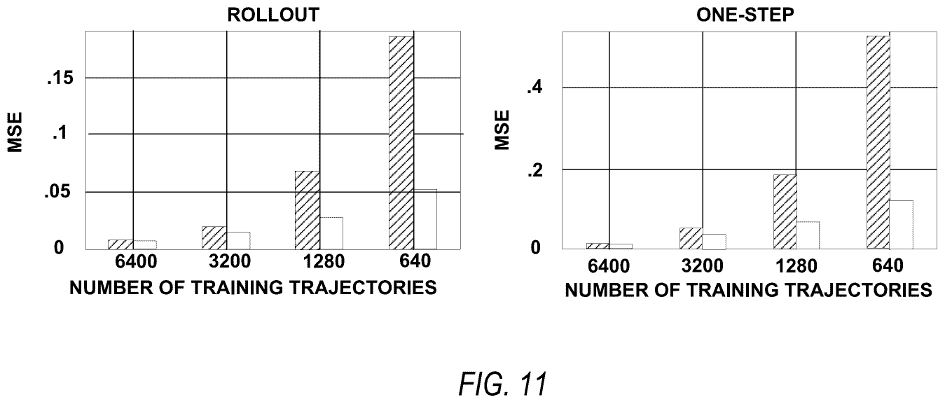

For the experiment, randomly place 18 (6 in the x-y plane, 6 in the x-z plane, 6 in the y-z plane) different light sources outside a cube which emit light with different amplitudes and different phase shifts, causing the resulting D and H fields to interfere with each other. Data was obtained on a grid with spatial resolution of 32×32×32 (Δx=Δy=Δz=5 10⁻⁷ m), and temporal resolution of Δt=50 s. FNO-based architectures were tested along with respective Clifford counterparts (CFNO). Note that Maxwell's equations are in general relatively simple due to the wave-like propagation of electric and magnetic fields. It is however a good playground to demonstrate the inductive bias advantages of Clifford based architectures, which leverage the vector-bivector character of electric and magnetic field components. Results for one-step loss and rollout loss on the test set are shown in FIG. 11.

The two fields are strongly coupled, e.g. temporal changes of electric fields induce magnetic fields and vice versa. Probably the most illustrative co-occurrence of electric and magnetic fields is when describing the propagation of light. In standard vector algebra, E is a vector while B is a pseudovector, i.e. the two kinds of fields are distinguished by a difference in sign under space inversion. F=E+Bi₃ naturally decomposes the electromagnetic field into vector and bivector parts via the pseudoscalar i₃. For example, for the base component Bₓe₁ of B it holds that Bₓe₁i₃=Bₓe₁ e₂e₃=Bₓe₂e₃, which is a bivector and the dual to the base component e₁ of E. Geometric algebra reveals that a pseudovector is nothing else than a bivector represented by its dual, so the magnetic field B in F=E+Bi₃ is fully represented by the complete bivector Bi₃, rather than B alone. Consequently, the multivector representing F consists of three vectors (the electric field components) and three bivectors e₁i₃=e₂e₃, e₂i₃=e₃e₁, e₃i₃=e₁e₂ (the magnetic field components multiplied by i₃).

FIG. 11 illustrates, by way of example, graphs of MSE versus number of training trajectories for FNO and CFNO NN architectures for Maxwell's Equations simulations. Note that CFNO architectures improve upon FNO architectures, especially for low numbers of trajectories. Results demonstrate the much stronger inductive bias of Clifford based 3-dimensional Fourier layers, and their general applicability to 3-dimensional problems, which are structurally even more interesting than 2-dimensional ones.

TABLE 4
Model comparison on four different metrics for neural PDE surrogates which
are trained on the Maxwell equations training datasets of varying size.
Results are obtained by using a two timestep history input. Error bars
are obtained by running experiments with three different initial seeds.

| | | SMSE | | | |
|---|---|---|---|---|---|
| Method | Trajs. | D | H | onestep | rollout |
| FNO | 640 | 0.0030 ± 0.0006 | 0.00233 ± 0.00050 | 0.0054 ± 0.0011 | 0.0186 ± 0.0083 |
| CFNO | | 0.0006 ± 0.0001 | 0.00072 ± 0.00010 | 0.0013 ± 0.0002 | 0.0054 ± 0.0023 |
| FNO | 1280 | 0.0010 ± 0.0002 | 0.00085 ± 0.00020 | 0.0019 ± 0.0004 | 0.0068 ± 0.0036 |
| CFNO | | 0.0003 ± 0.0001 | 0.00041 ± 0.00010 | 0.0007 ± 0.0002 | 0.0029 ± 0.0016 |
| FNO | 3200 | 0.0003 ± 0.0001 | 0.00025 ± 0.00010 | 0.0005 ± 0.0001 | 0.0020 ± 0.0011 |
| CFNO | | 0.0002 ± 0.0000 | 0.00020 ± 0.00010 | 0.0004 ± 0.0001 | 0.0015 ± 0.0009 |
| FNO | 6400 | 0.0001 ± 0.0000 | 0.00009 ± 0.00000 | 0.0002 ± 0.0000 | 0.0008 ± 0.0004 |
| CFNO | | 0.0001 ± 0.0000 | 0.00009 ± 0.00000 | 0.0002 ± 0.0000 | 0.0007 ± 0.0004 |

Embodiments introduce Clifford neural layers. A convolutional Clifford layer, Fourier Clifford layer, rotational Clifford convolutional layer, and an equivariant Clifford layer are provided. The Clifford neural layers handle the various scalar (e.g., charge density), vector (e.g. electric field), bivector (magnetic field) and higher order fields as proper geometric objects organized as multivectors. This geometric algebra perspective, provide for a natural generalizable convolution and Fourier transformation to their Clifford counterparts. Embodiments provide an elegant and natural rule to design new neural network layers. The multivector viewpoint of the Clifford neural layers led to better representation of the relationship between different fields and their individual components, allowing for significant outperformance of equivalent standard architectures for neural PDE surrogates. The performance gap increased with less data availability across all settings, denoting better inductive bias of the Clifford neural layers.

One limitation is the current speed of Fast Fourier Transform (FFT) operations on machine learning accelerators like graphics processing units (GPUs). While an active area of research, current available versions of cuFFT kernels wrapped in PyTorch are not yet as heavily optimized, especially for the gradient pass. Furthermore, FFTs of real-valued signals are Hermitian-symmetric, and outputs contain only positive frequencies below the Nyquist frequency. Such real-valued FFTs are used for Fourier Neural Operator (FNO) layers. Clifford Fourier layers on the other hand use complex-valued FFT operations where the backward pass is approximately twice as slow. For similar parameter counts, inference times of FNO and CFNO networks are similar. The speed of geometric convolution layers was already investigated. On the one hand, Clifford convolutions are more parameter efficient than the standard convolutions since they share parameters among filters, on the other hand, the net number of operations is larger for the same number of parameters resulting in increased training times by a factor of about 2. Finally, from a PDE point of view, the presented approaches to obtain PDE surrogates are limited since the NN have to be retrained for different equation parameters or e.g., different At. Custom multivector GPU kernels can overcome many of the speed issues as the compute density of Clifford operations is much higher which is better for hardware accelerators

Besides PDE modeling, weather predictions, electro-magnetic field interactions, and fluid dynamics, applications of multivector representations and Clifford layers can be found in neural implicit representations.

A closer look at Cl_{2,0}(R), Cl_{0,2}(R), and Cl_{3,0}(R) is now provided. A vector space over a field F is a set V together with two binary operations that satisfy the axioms for vector addition and scalar multiplication. The axioms of addition ensure that if two elements of V get added together, another element of V is provided as a result. The elements of F are called scalars. Examples of a field F are the real numbers R and the complex numbers C. Although it is common practice to refer to the elements of a general vector space V as vectors, to avoid confusion this discussion reserves the usage of this term to the more specific case of elements of Rⁿ. As shown below, general vector spaces can consist of more complicated, higher-order objects than scalars, vectors or matrices.

An algebra over a field consists of a vector space V over a field F together with an additional bilinear law of composition of elements of the vector space, V×V→V, that is, if a and b are any two elements of V, then ab: V×V→V is an element of V, satisfying a pair of distribution laws: a(λ₁b+λ₂c)=λ₁ab+λ₂ac and (λ₁a+λ₂b)c=λ₁ac+λ₂bc for λ₁, λ₂∈F and a, b, c∈V. Note that general vector spaces do not have bilinear operations defined on their elements.

Focus is now on Clifford algebras over R. A real Clifford algebra is generated by the n-dimensional vector space Rⁿ through a set of relations that hold for the basis elements of the vector space Rⁿ. Denote the basis elements of Rⁿ with e₁, . . . , eₙ, and without loss of generality choose these basis elements to be mutually orthonormal. Take two non-negative integers p and q, such that p+q=n, then a real Clifford algebra Cl_{p,q}(R) with the “signature” (p, q), is generated through the following relations that define how the bilinear product of the algebra operates on the basis elements of Rⁿ:

eᵢ²=+1 for 1≤i≤p, (19)

eⱼ²=−1 for p<j≤p+q, (20)

eᵢeⱼ=−eⱼeᵢ for i≠j. (21)

Through these relations one can generate a basis for the vector space of the Clifford algebra, which we is denoted by G. Equations 19 and 20 show that the product between two vectors yields a scalar. According to the aforementioned definition of an algebra over a field, a Clifford algebra with a vector space G is equipped with a bilinear product G×G→G, that combines two elements from the vector space G and yields another element of the same space G. Therefore, both scalars and vectors are elements of the vector space G. Equation 21 shows that besides scalar and vector elements, higher order elements including a combination of two basis elements, such as eᵢeⱼ and eⱼeᵢ, are also part of the vector space G. By combining Equations 19, 20, 21 one can create even higher order elements such as eᵢeⱼeₖ for i≠j≠k, or e₁e₂ . . . e_{p+q}, which all must be part of the vector space G.

To determine the basis elements that span the vector space G of Cl_{p,q}(R), note that elements e_{σ(1)}e_{σ(2)} . . . e_{σ(k)} and e₁e₂ . . . eₖ are related through a simple scalar multiplicative factor of plus or minus one, depending on the sign of the permutation σ. Therefore, it suffices to consider the unordered combinations of basis elements of Rⁿ: the basis of the vector space G is given by {1, e₁, e₂, . . . e_{p+q}, e₁e₂, . . . , e_{p+q-1}e_{p+q}, . . . , e₁e₂ . . . e_{p+q}}.

In summary, two different vector spaces have been introduced. First, the vector space Rⁿ which generates the Clifford algebra, and second the vector space G, which is the vector space spanned by the basis elements of the Clifford algebra Cl_{p,q}(R). Convention is to denote the vector space of a real Clifford algebra with a superscript n of the dimension of the generating vector space, yielding Gⁿ for a generating vector space Rⁿ. Note that the dimension of the vector space Gⁿ is 2ⁿ=2^{p+q}.

Common examples of low-dimensional Clifford algebras are: (i) Cl_{0,0}(R) which is a one-dimensional algebra that is spanned by the vector {1} and is therefore isomorphic to R, the field of real numbers; (ii) Cl_{0,1}(R) which is a two-dimensional algebra with vector space G¹ spanned by {1, e₁} where the basis vector e₁ squares to −1, and is therefore isomorphic to C, the field of complex numbers; (iii) Cl_{0,2}(R) which is a 4-dimensional algebra with vector space G² spanned by {1, e₁, e₂, e₁e₂}, where e₁, e₂, e₁e₂ all square to −1 and anti-commute. Thus, Cl_{0,2}(R) is isomorphic to the quaternions H.

The grade of a Clifford algebra basis element is the dimension of the subspace it represents. For example, the basis elements {1, e₁, e₂, e₁e₂} of the Clifford algebras Cl_{0,2}(R) and Cl_{2,0}(R) have the grades {0, 1, 1, 2}. Using the concept of grades, one can divide the vector spaces of Clifford algebras into linear subspaces made up of elements of each grade. The grade subspace of smallest dimension is M₀, the subspace of all scalars (elements with 0 basis vectors). Elements of M₁ are called vectors, elements of M₂ are bivectors, and so on. In general, the vector space G^{p+q} of a Clifford algebra Cl_{p,q} can be written as the direct sum of all of these subspaces:

G^{p+q}=M₀⊕M₁⊕ . . . ⊕M_{p+q}. (22)

The elements of a Clifford algebra are called multivectors, containing elements of subspaces (e.g., scalars, vectors, bivectors, trivectors, etc.). The basis element with the highest grade is called the pseudoscalar, which in R² corresponds to the bivector e₁e₂, and in R³ to the trivector e₁e₂e₃. The pseudoscalar is often denoted with the symbol i_{p+q}.

Using Equations 19, 20, 21, it is seen how basis elements of the vector space G^{p}^{⁺}^{q} of the Clifford algebra are formed using basis elements of the generating vector space V. Note how elements of G^{p}^{⁺}^{q} are combined, in other words, how multivectors are bilinearly operated on. The geometric product is the bilinear operation on multivectors in Clifford algebras. For arbitrary multivectors a, b, c∈G^{p}^{⁺}^{q}, and scalar λ the geometric product has the following properties:

ab∈G^{p+q} closure (23)

(ab)c=a(bc) associativity (24)

λa=λaλ commutative scalar multiplication (25)

a(b+c)=ab+ac distributive over addition (26)

The geometric product is in general non-commutative, i.e. ab≠ba. The geometric product is made up of two things: an inner product (that captures similarity) and exterior (wedge) product that captures difference.

The dual a* of a multivector a is defined as:

a*=ai_{p+q} (27),

where i_{p+q} represents the respective pseudoscalar of the Clifford algebra.

This definition allows one to relate different multivectors to each other, which is a useful property when defining Clifford Fourier transforms. For example, for Clifford algebras in R² the dual of a scalar is a bivector, and for the Clifford algebra R³ the dual of a scalar is a trivector.

The Clifford algebra Cl_{0,1}(R) is a two-dimensional algebra with vector space G¹ spanned by {1, e₁}, and where the basis vector el squares to −1. Cl_{0,1}(R) is thus algebra-isomorphic to C, the field of complex numbers. This becomes more obvious by identifying that the basis element with the highest grade, i.e. e₁, as the pseudoscalar i¹ which is the imaginary part of the complex numbers. The geometric product between two multivectors a=a₀+a₁e₁ and b=b₀+b₁e₁ is therefore also isomorphic to the product of two complex numbers:

ab=a₀b₀+a₀b₁e₁+a₁b₀e₁+a₁b₁e₁e₁=(a₀b₀−a₁b₁)+(a₀b₁+a₁b₀)e₁ (28)

The Clifford algebra Cl_{2,0}(R) is a 4-dimensional algebra with vector space G² spanned by the basis vectors {1, e₁, e₂, e₁e₂} where e₁, e₂, e₁e₂ all square to +1. The geometric product of two multivectors a=a₀+a₁e₁+a₂e₂+a₁₂e₁e₂ and b=b₀+b₁e₁+b₂e₂+b₁₂e₁e₂ is defined as:

ab=a₀b₀+a₀b₁e₁+a₀b₂e₂+a₀b₁₂e₁e₂+a₁b₀e₁+a₁b₁e₁e₁+a₁b₂e₁e₂+a₁b₁₂e₁e₁e₂+a₂b₀e₂+a₂b₁e₂e₁+a₂b₂e₂e₂+a₂b₁₂e₂e₁e₂+a₁₂b₀e₁e₂+a₁₂b₁e₁e₂e₁+a₁₂b₂e₁e₂e₂+a₁₂b₁₂e₁e₂e₁e₂. (29)

Using the relations e₁e₁=1, e₂e₂=1, and eᵢeⱼ=−eⱼeᵢ, for i≠j≠{e₁, e₂}, from which it follows that e₁e₂e₁e₂=−1, and:

ab=a₀b₀+a₁b₁+a₂b₂−a₁₂b₁₂+(a₀b₁+a₁b₀−a₂b₁₂+a₁₂b₂)e₁+(a₀b₂+a₁b₁₂−a₂b₀+a₁₂b₁)e₂+(a₀b₁₂+a₁b₂−a₂b₁+a₁₂b₀)e₁e₂. (30)

A vector x∈R²⊂G² is identified with x₁e₁+x₂e₂∈R²⊂G². Clifford multiplication of two vectors

x, y∈R²⊂G² yields the geometric product xy:

$$x y = ( {x}_{1} {e}_{1} + {x}_{2} {e}_{2} ) ( {y}_{1} {e}_{1} + {y}_{2} {e}_{2} ) = {\underbrace{{x}_{1} {y}_{1} {e}_{1}^{2} + {x}_{2} {y}_{2} {e}_{2}^{2}}}_{inner product 〈 x , y 〉} + {\underbrace{{x}_{1} {y}_{2} {e}_{1} {e}_{2} + {x}_{2} {y}_{1} {e}_{2} {e}_{1}}}_{outer / wedge product x ⋀ y} \qquad ( 31 )$$

The asymmetric quantity x∧y=−y∧x is associated with the bivector, which can be interpreted as an oriented plane segment.

Equation 31 can be rewritten to express the (symmetric) inner product and the (anti-symmetric) outer product in terms of the geometric product:

x∧y=½(xy−yx) (32)

[symbol]

x, y [symbol] =½(x+yx) (33)

From the basis vectors of the vector space G² of the Clifford algebra Cl_{2,0}(R), i.e. {1, e₁, e₂, e₁e₂}, probably the most interesting is e₁e₂. A closer look at the unit bivector i₂=e₁e₂ which is the plane spanned by e₁ and e₂ and determined by the geometric product is provided:

$${i}_{2} = {e}_{1} {e}_{2} = {\underbrace{〈 {e}_{1} , {e}_{2} 〉}}_{= 0} + {e}_{1} ⋀ {e}_{2} = - {e}_{1} ⋀ {e}_{2} = - {e}_{2} {e}_{1} \qquad ( 34 )$$

where the inner product [symbol] e₁, e₂ [symbol] is zero due to the orthogonality of the base vectors. The bivector i₂, if squared yields i₂²=−1, and thus i₂ represents a true geometric \sqrt{−1}. From Equation 34, it follows that

e₂=e₁i₂=−i₂e₁

e₁=i₂e₂=−e₂i₂. (35)

The dual of a multivector a∈G² is defined via the bivector as i₂a. Thus, the dual of a scalar is a bivector and the dual of a vector is again a vector. The dual pairs of the base vectors are 1↔e₁e₂ and e₁↔e₂. These dual pairs allow one to write an arbitrary multivector a as

$$a = {a}_{0} + {a}_{1} {e}_{1} + {a}_{2} {e}_{2} + {a}_{12} {e}_{12} , \qquad ( 36 )$$

$$a = 1 {\underbrace{( {a}_{0} + {a}_{12} {i}_{2} )}}_{spinor part} + {e}_{1} {\underbrace{( {a}_{1} + {a}_{2} {i}_{2} )}}_{vector part}$$

which can be regarded as two complex-valued parts: the spinor part, which commutes with i₂ and the vector part, which anti-commutes with i₂.

The Clifford algebra Cl_{0,2}(R) is a 4-dimensional algebra with vector space G² spanned by the basis vectors {1, e₁, e₂, e₁e₂} where e₁, e₂, e₁e₂ all square to −1. The Clifford algebra Cl_{0,2}(R) is algebra-isomorphic to the quaternions H, which are commonly written as a+bî+cĵ+d\hat{k}, where the (imaginary) base elements î, ĵ, \hat{k} fulfill the relations:

î²=ĵ²=−1

îĵ=\hat{k}

îĵ=−\hat{k}

\hat{k}²=îĵîĵ=−îĵĵî=îî=−1. (37)

Quaternions also form a 4-dimensional algebra spanned by {1, î, ĵ, \hat{k}}, where î, ĵ, \hat{k} all square to −1. The basis element 1 is often called the scalar part, and the basis elements î, ĵ, \hat{k} are called the vector part of a quaternion. The geometric product of two multivectors in Cl_{0,2}(R) is shown in Equations (29) and (30).

The Clifford algebra is an 8-dimensional algebra with vector space G³ spanned by the basis vectors {1, e₁, e₂, e₃, e₁e₂, e₁e₃, e₂ e₃, e₁e₂e₃} i.e. one scalar, three vectors {e₁, e₂, e₃}, three bivectors {e₁e₂, e₁e₃, e₂e₃}, and one trivector e₁e₂e₃. The trivector is the pseudoscalar i₃ of the algebra. The geometric product of two multivectors is defined analogously to the geometric product of Cl_{2,0}(R), following the associative and bilinear multiplication of multivectors follows:

eᵢ²=1 for i=1,2,3 (38)

eᵢeⱼ=−eᵢeⱼ for i,j=1,2,3,i≠j (39)

Using Definition 2, the dual pairs of Cl_{3,0} are:

1↔e₁e₂e₃=i₃ (40)

e₁↔e₂e₃ (41)

e₂↔e₃e₁ (42)

e₃↔e₁e₂. (43)

The geometric product for Cl_{3,0}(R) is defined analogously to the geometric product of Cl_{2,0}(R) via:

ab=a₀b₀+a₀b₁e₁+a₀b₂e₂+a₀b₃e₃+a₀b₁₂e₁e₂+a₀b₁₃e₁e₃+a₀b₂₃e₂e₃+a₀b₁₂₃e₁e₂e₃+a₁b₀e₁+a₁b₁e₁e₁+a₁b₂e₁e₂+a₁b₃e₁e₃+a₁b₁₂e₁e₁e₂+a₁b₁₃e₁e₁e₃+a₁b₂₃e₁e₂e₃+a₁b₁₂₃e₁e₁e₂e₃+a₂b₀e₂+a₂b₁e₂e₁+a₂b₂e₂e₂+a₂b₃e₂e₃+a₂b₁₂e₂e₁e₂+a₂b₁₃e₁e₃e₂+a₂b₂₃e₂e₂e₃−a₂b₁₂₃e₂e₂e₁e₃+a₃b₀e₃+a₃b₁e₃e₁+a₃b₂e₃e₂+a₃b₃e₃e₃+a₃b₁₂e₁e₃e₂+a₃b₁₃e₁e₃e₃−a₃b₂₃e₂e₃e₃+a₃b₁₂₃e₁e₂e₃e₃+a₁₂b₀e₁e₂−a₁₂b₁e₂e₁e₁+a₁₂b₂e₁e₂e₂+a₁₂b₃e₁e₂e₃+a₁₂b₁₂e₁e₂e₁e₂−a₁₂b₁₃e₁e₂e₂e₃+a₁₂b₂₃e₂e₂e₁e₃+a₁₂b₁₂₃e₁e₂e₁e₂e₃+a₁₃b₀e₁e₃−a₁₃b₁e₂e₁e₁+a₁₃b₂e₁e₃e₂+a₁₃b₃e₁e₃e₃−a₁₂b₁₂e₁e₁e₃e₂+a₁₃b₁₃e₁e₃e₁e₃−a₁₃b₂₃e₁e₂e₃e₃+a₁₃b₁₂₃e₁e₃e₁e₂e₃+a₂₃b₀e₂e₃+a₂₃b₁e₁e₃e₂+a₂₃b₂e₂e₃e₂+a₂₃b₃e₂e₃e₃+a₂₃b₁₂e₂e₃e₁e₂−a₂₃b₁₃e₂e₁e₃e₃+a₂₃b₂₃e₂e₃e₂e₃+a₂₃b₁₂₃e₂e₃e₁e₂e₃+a₁₂₃b₀e₁e₂e₃−a₁₂₃b₁e₁e₂e₃e₁+a₁₂₃b₂e₁e₃e₁e₂+a₁₂₃b₃e₁e₂e₃e₃+a₁₂₃b₁₂e₁e₂e₂e₁e₂+a₁₂₃b₁₃e₁e₂e₃e₁e₃+a₁₂₃b₂₃e₁e₂e₃e₂e₃+a₁₂₃b₁₂₃e₁e₂e₃e₁e₂e₃ (44)

Where minus signs appear due to reordering of basis elements. Equation 44 simplifies to:

ab=a₀b₀+a₁b₁+a₂b₂+a₃b₃−a₁₂b₁₂−a₁₃b₁₃−a₂₃b₂₃−a₁₂₃b₁₂₃+(a₀b₁+a₁b₀−a₂b₁₂−a₃b₁₃+a₁₂b₂+a₁₃b₃−a₂₃b₁₂₃−a₁₂₃b₂₃)e₁+(a₀b₂+a₁b₁₂+a₂b₀−a₃b₂₃−a₁₂b₁+a₁₃b₁₂₃+a₂₃b₃+a₁₂₃b₁₃)e₂+(a₀b₃+a₁b₁₃+a₂b₂₃−a₃b₀−a₁₂b₁₂₃−a₁₃b₁−a₂₃b₂−a₁₂₃b₁₂)e₃+(a₀b₁₂+a₁b₂−a₂b₁+a₃b₁₂₃+a₁₂b₀−a₁₃b₂₃+a₂₃b₁₃+a₁₂₃b₃)e₂e₂+(a₀b₁₃+a₁b₃−a₂b₁₂₃−a₃b₁+a₁₂b₂₃+a₁₃b₀−a₂₃b₁₂−a₁₂₃b₂)e₁e₃+(a₀b₂₃+a₁b₁₂₃+a₂b₃−a₃b₂−a₁₂b₁₃−a₁₃b₁₂+a₂₃b₀+a₁₂₃b₁)e₂e₃+(a₀b₁₂₃+a₁b₂₃−a₂b₁₃+a₃b₁₂+a₁₂b₃−a₁₃b₂+a₂₃b₁+a₁₂₃b₀)e₁e₂e₃. (45)

A derivation of the implementation of translation equivariant Clifford convolution layers for multivectors in G², multivectors of Clifford algebras generated by the 2-dimensional vector space R², is now provided. Refer to Equations (8)-(10) for details regarding a Clifford Convolution layer. Then an extension to Clifford algebras generated by the 3-dimensional vector space R³ is described.

Let ƒ:Z²→(G²)^{c}in be a multivector feature map and let w:Z²→(G²)^{Cin} be a multivector kernel, then [[Lₜƒ]★w](x)=[Lₜ[ƒ★w]](x). Proof.

$$[ [ {L}_{t} f ] ★ w ] ( x ) = {\sum }_{y ∈ {Z}^{2}} {\sum }_{j = 1}^{{c}_{i n}} f ( y - t ) w ( y - x ) = {\sum }_{y ∈ {Z}^{2}} {\sum }_{j = 1}^{{c}_{i n}} {f}_{0} ( y - t ) {w}_{0} ( y - x ) + {f}_{1} ( y - t ) {w}_{1} ( y - x ) + {f}_{2} ( y - t ) {w}_{2} ( y - x ) - {f}_{12} ( y - t ) {w}_{12} ( y - x ) + ( {f}_{0} ( y - t ) {w}_{1} ( y - x ) + {f}_{1} ( y - t ) {w}_{0} ( y - x ) - {f}_{2} ( y - t ) {w}_{12} ( y - x ) + {f}_{12} ( y - t ) {w}_{2} ( y - x ) ) {e}_{1} + ( {f}_{0} ( y - t ) {w}_{2} ( y - x ) + {f}_{1} ( y - t ) {w}_{12} ( y - x ) + {f}_{2} ( y - t ) {w}_{0} ( y - x ) - {f}_{12} ( y - t ) {w}_{1} ( y - x ) ) {e}_{2} + ( {f}_{0} ( y - t ) {w}_{12} ( y - x ) + {f}_{1} ( y - t ) {w}_{2} ( y - x ) - {f}_{2} ( f - t ) {w}_{1} ( y - x ) + {f}_{12} ( y - t ) {w}_{0} ( y - x ) ) {e}_{1} {e}_{2} + {f}_{0} ( y - t ) {w}_{12} ( y - x ) + {f}_{1} ( y - t ) {w}_{2} ( y - x ) - {f}_{2} ( f - t ) {w}_{1} ( y - x ) + {f}_{12} ( y - t ) {w}_{0} ( y - x ) ( using y \to y - t ) = {\sum }_{y ∈ {Z}^{2}} {\sum }_{j = 1}^{{c}_{i n}} {f}_{0} ( y ) {w}_{0} ( y - ( x - t ) ) + {f}_{1} ( y ) {w}_{1} ( y - ( x - t ) ) + {f}_{2} ( y ) {w}_{2} ( y - ( x - t ) ) - {f}_{12} ( y ) {w}_{12} ( y - ( x - t ) ) + ( {f}_{0} ( y ) {w}_{1} ( y - ( x - t ) ) + {f}_{1} ( y ) {w}_{0} ( y - ( x - t ) ) - {f}_{2} ( y ) {w}_{12} ( y - ( x - t ) ) + {f}_{12} ( y ) {w}_{2} ( y - ( x - t ) ) ) {e}_{1} + ( {f}_{0} ( y ) {w}_{2} ( y - ( x - t ) ) + {f}_{1} ( y ) {w}_{12} ( y - ( x - t ) ) + {f}_{2} ( y ) {w}_{0} ( y - ( x - t ) ) - {f}_{12} ( y ) {w}_{1} ( y - ( x - t ) ) ) {e}_{2} + ( {f}_{0} ( y ) {w}_{12} ( y - ( x - t ) ) + {f}_{1} ( y ) {w}_{2} ( y - ( x - t ) ) - {f}_{2} ( y ) {w}_{1} ( y - ( x - t ) ) + {f}_{12} ( y ) {w}_{0} ( y - ( x - t ) ) ) {e}_{1} {e}_{2} = [ {L}_{t} [ f ★ w ] ] ( x ) . \qquad ( 46 )$$

Implementation of Cl_{2,0}(R) layers is now discussed in more detail. One can implement a 2D Clifford CNN layer using Equation 30 where {b₀, b₁, b₂, b₁₂}→{w₀^{i,j}, w₁^{i,j}, w₂^{i,j}, w₁₂^{i,j}} correspond to 4 different kernels representing one 2D multivector kernel, i.e. 4 different convolution layers, and {a₀, a₁, a₂, a₁₂}→{ƒ₀^{j}, ƒ₁^{j}, ƒ₂^{j}, ƒ₁₂^{j}} correspond to the scalar, vector and bivector parts of the input multivector field. The channels of the different layers represent different stacks of scalars, vectors, and bivectors. All kernels have the same number of input and output channels (number of input and output multivectors), and thus the channels mixing occurs for the different terms of Equations 30, 45 individually. Lastly, usually not all parts of the multivectors are present in the input vector fields. This can easily be accounted for by just omitting the respective parts of Equations 30, 45. A similar reasoning applies to the output vector fields.

An alternative parameterization to the Clifford CNN layer introduced in Equation 9 can be realized by using the isomorphism of the Clifford algebra Cl_{0,2}(R) to quaternions. This alternative parameterization takes advantage of the fact that a quaternion rotation can be realized by a matrix multiplication. Using the isomorphism, one can represent the feature maps ƒ^{j} and filters w^{i,j} as quaternions: ƒ^{j}=ƒ₀^{j}+ƒ₁^{j}î+ƒ₂^{j}ĵ+ƒ₃^{j}\hat{k} and w₀^{i,j}=w₀^{i,j}+w₁^{i,j}î+w₂^{i,j}ĵ+w₃^{j}\hat{k}. Leveraging this quaternion representation, the alternative parameterization of a product between the feature map ƒ^{j} and w^{i,j} can be realized. To be more precise, consider a composite operation that results in a scalar quantity and a quaternion rotation, where the latter acts on the vector part of the quaternion ƒ^{j} and only produces nonzero expansion coefficients for the vector part of the quaternion output. A quaternion rotation w^{i,j}ƒ^{j}(w^{i,j})⁻¹ acts on the vector part (î, ĵ, \hat{k}) of ƒ^{j}, and can be algebraically manipulated into a vector-matrix operation R^{i,j}ƒ^{j}, where R^{i,j}: H→H is built up from the elements of w^{i,j}. In other words, one can transform the vector part (î, ĵ, \hat{k}) of ƒ^{j}∈H via a rotation matrix R^{i,j} that is built from the scalar and vector part (1, (î, ĵ, \hat{k}) of w^{i,j} ∈H. Altogether, a rotational multivector filter {wᵣₒₜⁱ}ᵢ₌₁^{c}^{ₒᵤₜ}: Z²→(G²) acts on the feature map ƒ^{j} through a rotational transformation R^{i,j}(wᵣₒₜ₀^{i,j}, wᵣₒₜ₁^{i,j}, wᵣₒₜ₂^{i,j}, wᵣₒₜ₁₂^{i,j}) acting on vector and bivector parts of the multivector feature map ƒ: Z²→(G²)^{c}in, and an additional scalar response of the multivector filters:

$$[ f ★ {w}_{rot}^{i} ] ( x ) = {\sum }_{y ∈ {Z}^{2}} {\sum }_{j = 1}^{{c}_{i n}} {f}^{j} ( y ) {w}_{r o t}^{i , j} ( y - x ) = {\sum }_{y ∈ {Z}^{2}} {\sum }_{j = 1}^{{c}_{i n}} {\underbrace{{[ {f}^{j} ( y ) {w}_{r o t}^{i , j} ( y - x ) ]}_{0}}}_{scalar output} + {R}^{i , j} ( y - x ) .$$

$$( \begin{matrix}{f}_{1}^{j} ( y ) \\ {f}_{2}^{j} ( y ) \\ {f}_{12}^{j} ( y )\end{matrix} )$$

$${Where [ {f}^{j} ( y ) {w}_{r o t}^{i , j} ( y - x ) ]}_{0} = {f}_{0}^{j} {w}_{r o t , 0}^{i , j} - {f}_{1}^{j} {w}_{r o t , 1}^{i , j} - {f}_{2}^{j} {w}_{r o t , 2}^{i , j} - {f}_{12}^{j} {w}_{r o t , 12}^{i , j} ,$$

which is the scalar output of Equation 30. The rotational matrix R^{i,j}(y−x) in written form is:

$${R}^{i , j} = ( \begin{matrix}1 - 2 ( {( {\hat{w}}_{rot , 2}^{i , j} )}^{2} + {( {\hat{w}}_{rot , 12}^{i , j} )}^{2} ) & 2 ( {\hat{w}}_{rot , 1}^{i , j} {\hat{w}}_{rot , 2}^{i , j} - {\hat{w}}_{rot , 0}^{i , j} {\hat{w}}_{rot , 12}^{i , j} ) & 2 ( {\hat{w}}_{rot , 1}^{i , j} {\hat{w}}_{rot , 12}^{i , j} - {\hat{w}}_{rot , 0}^{i , j} {\hat{w}}_{rot , 2}^{i , j} ) \\ 2 ( {\hat{w}}_{rot , 1}^{i , j} {\hat{w}}_{rot , 2}^{i , j} - {\hat{w}}_{rot , 0}^{i , j} {\hat{w}}_{rot , 12}^{i , j} ) & 1 - 2 ( {( {\hat{w}}_{rot , 1}^{i , j} )}^{2} + {( {\hat{w}}_{rot , 12}^{i , j} )}^{2} ) & 2 ( {\hat{w}}_{rot , 2}^{i , j} {\hat{w}}_{rot , 12}^{i , j} - {\hat{w}}_{rot , 0}^{i , j} {\hat{w}}_{rot , 1}^{i , j} ) \\ 2 ( {\hat{w}}_{rot , 1}^{i , j} {\hat{w}}_{rot , 12}^{i , j} - {\hat{w}}_{rot , 0}^{i , j} {\hat{w}}_{rot , 2}^{i , j} ) & 2 ( {\hat{w}}_{rot , 2}^{i , j} {\hat{w}}_{rot , 12}^{i , j} - {\hat{w}}_{rot , 0}^{i , j} {\hat{w}}_{rot , 12}^{i , j} ) & 1 - 2 ( {( {\hat{w}}_{rot , 1}^{i , j} )}^{2} + {( {\hat{w}}_{rot , 2}^{i , j} )}^{2} )\end{matrix} )$$

$$Where {\hat{w}}_{rot}^{i , j} ( y - x ) = {\hat{w}}_{rot , 0}^{i , j} ( y - x ) + {\hat{w}}_{rot , 1}^{i , j} ( y - x ) {e}_{i} + {\hat{w}}_{rot , 2}^{i , j} ( y - x ) {e}_{2} + {\hat{w}}_{rot , 12}^{i , j} ( y - x ) {e}_{12}$$

is the normalized filter with ∥ŵᵣₒₜ^{i,j}∥=1. The dependency (y−x) is omitted inside the rotation matrix R^{i,j} for clarity.

Analogous to the 2-dimensional case, one can implement a 3D Clifford CNN layer using Equation 45, where {b₀, b₁, b₂, b₁₂, b₁₃, b₂₃, b₁₂₃} correspond to 8 different kernels representing one 3D multivector kernel, i.e. 8 different convolution layers, and {a₀, a₁, a₂, a₁₂, a₁₃, a₂₃, a₁₂₃} correspond to the scalar, vector, bivector, and trivector parts of the input multivector field.

Different normalization schemes have been proposed to stabilize and accelerate training DNNs. Their standard formulations apply only to real values. Simply translating and scaling multivectors such that their mean is 0 and their variance is 1 is insufficient because it does not ensure equal variance across all components.

A batch normalization formulation can be applied to complex values. B uild on the same principles can provide an appropriate batch normalization scheme for multivectors. For 2D multivectors of the form a=a₀+a₁e₁+a₂e₂+a₁₂e₁e₂, one can formulate the problem of batch normalization as that of whitening 4D vectors:

$$\tilde{a} = {( V )}^{- \frac{1}{2}} ( a - E [ a ] ) \qquad ( 47 )$$

where the covariance matrix V is

$$V = ( \begin{matrix}{V}_{{a}_{0} {a}_{0}} & {V}_{{a}_{0} {a}_{1}} & {V}_{{a}_{0} {a}_{2}} & {V}_{{a}_{0} {a}_{12}} \\ {V}_{{a}_{1} {a}_{0}} & {V}_{{a}_{1} {a}_{1}} & {V}_{{a}_{1} {a}_{2}} & {V}_{{a}_{1} {a}_{12}} \\ {V}_{{a}_{2} {a}_{0}} & {V}_{{a}_{2} {a}_{1}} & {V}_{{a}_{2} {a}_{2}} & {V}_{{a}_{2} {a}_{12}} \\ {V}_{{a}_{12} {a}_{0}} & {V}_{{a}_{12} {a}_{1}} & {V}_{{a}_{12} {a}_{2}} & {V}_{{a}_{12} {a}_{12}}\end{matrix} )$$

The shift parameter β is a multivector parameter with 4 learnable components and the scaling parameter y is 4×4 positive semi-definite matrix. The multivector batch normalization is defined as:

BN(a)=γa+β (48)

When the batch sizes are small, it can be more appropriate to use Group Normalization or Layer Normalization. These can be derived with appropriate application of Equation 47 along appropriate tensor dimensions.

Similar to Clifford normalization, quaternion initialization schemes can be adapted to Clifford layers. Effectively, tighter bounds are required for the uniform distribution form which Clifford weights are sampled. However, despite intensive studies no performance gains were observed over default PyTorch initialization schemes for 2-dimensional experiments. However, 3-dimensional implementations necessitate much smaller initialization values (e.g., about a factor of about ⅛).

Clifford convolutions satisfy the property of equivariance under translation of the multivector inputs, as shown. However, the current definition of Clifford convolutions is not equivariant under multivector rotations or reflections. Here, a general kernel constraint is derived which allows building generalized Clifford convolutions which are equivariant with respect to rotations or reflections of the multivectors. That is, equivariance of a Clifford layer under rotations and reflections (i.e. orthogonal transformations) is proved if the multivector kernel multivector filters {wⁱ}ᵢ₌₁^{c}^{ₒᵤₜ}:Z²→(G)^{c}in satisfies the constraint:

w^{i,j}(Tx)=Tw^{i,j}(x),

for 0≤j<cᵢₙ. First define an orthogonal transformation on a multivector by,

Tƒ=±uƒu^{†}, u^{†}u=1 (49)

where u and ƒ are multivectors which are multiplied using the geometric product. The minus sign is picked up from reflections but not by rotations, i.e. it depends on the parity of the transformation. This construction is called a “versor” product. The above construction makes it immediately clear that T(ƒg)=(Tƒ)(Tg). Tx means an orthogonal transformation of a Euclidean vector (which can in principle also be defined using versors). To show equivariance, prove for multivectors ƒ: Z²→(G)^{c}in and a set of cₒᵤₜ multivector filters {wⁱ}ᵢ₌₁^{c}^{ₒᵤₜ}:Z²→(G)^{c}in that:

ƒ′(Tx)=Tƒ(x), (50)

And

wⁱ(Tx)=Twⁱ(x), (51)

Equations 50, 51 yield:

⇒[ƒ★wⁱ]′(Tx)=T[ƒ★wⁱ](x) (52)

That is, if the input multivector field transforms as a multivector, and the kernel satisfies the stated equivariance constraint, then the output multivector field also transforms properly as a multivector. Note that T might act differently on the various components (scalars, vectors, pseudoscalars, pseudovectors) under rotations and/or reflections.

Now,

$$\begin{matrix}{[ f ★ {w}^{i} ]}^{′} ( Tx ) = {\sum }_{y ∈ {Z}^{2}} {\sum }_{j = 1}^{{c}_{in}} {f}^{′ j} ( y ) {w}^{i , j} ( y - Tx ) \\ = {\sum }_{y ∈ {Z}^{2}} {\sum }_{j = 1}^{{c}_{in}} {f}^{′ j} ( y ) {w}^{i , j} ( T ( {T}^{- 1} y - x ) \\ = {\sum }_{{Ty}^{′} ∈ {Z}^{2}} {\sum }_{j = 1}^{{c}_{in}} {f}^{′ j} ( {Ty}^{′} ) {w}^{i , j} ( T ( {y}^{′} - x ) ) , {y}^{′} = {T}^{- 1} y , \\ = {\sum }_{{y}^{′} ∈ {Z}^{2}} {\sum }_{j = 1}^{{c}_{in}} {f}^{′ j} ( {Ty}^{′} ) {w}^{i , j} ( T ( {y}^{′} - x ) ) \\ = {\sum }_{{y}^{′} ∈ {Z}^{2}} {\sum }_{j = 1}^{{c}_{in}} {Tf}^{j} ( {y}^{′} ) {Tw}^{i , j} ( {y}^{′} - x ) \\ = {\sum }_{{y}^{′} ∈ {Z}^{2}} {\sum }_{j = 1}^{{c}_{in}} {Tf}^{j} ( {y}^{′} ) {Tw}^{i , j} ( {y}^{′} - x ) \\ = T {\sum }_{{y}^{′} ∈ {Z}^{2}} {\sum }_{j = 1}^{{c}_{in}} ( {f}^{j} ( {y}^{′} ) {w}^{i , j} ( {y}^{′} - x ) ) \\ = T [ f ★ {w}^{i} ] ( x )\end{matrix}$$

where in the fourth line variables are transformed as y→y′, in the fifth line the invariance of the summation “measure” under T is used, in the sixth line the transformation property of ƒ and equivariance for wⁱ is used, in the seventh line the property of multivectors is used, and in the eighth line linearity of T is used.

An implementation of Clifford Fourier layers for multivectors in G² and G³, i.e. multivectors of Clifford algebras generated by the 2-dimensional vector space R² and the 3-dimensional vector space R³ is now derived. In arbitrary dimension n, the Fourier transform \hat{ƒ}(ξ)= [symbol] {ƒ}(ξ) for a continuous n-dimensional complex-valued signal ƒ(x)=ƒ(x₁, . . . , xₙ): Rⁿ→C is defined as:

$$\hat{f} ( ξ ) = ℱ \{ f \} ( ξ ) = 1 / {( 2 π )}^{\frac{n}{2}} {\int }_{{R}^{n}} f ( x ) {e}^{- 2 πi 〈 x , ξ 〉} d x , ∀ ξ ∈ {R}^{n} \qquad ( 53 )$$

provided that the integral exists, where x and ξ are n-dimensional vectors and <x, ξ> is the contraction of x and ξ. Usually, <x, ξ> is the inner product, and ξ is an element of the dual vector space R^{n★}. The inversion theorem states the back-transform from the frequency domain into the spatial domain:

$$f ( x ) = {ℱ}^{- 1} \{ ℱ \{ f \} \} ( x ) = 1 / {( 2 π )}^{\frac{n}{2}} {\int }_{{R}^{n}} \hat{f} ( ξ ) {e}^{2 πi 〈 x , ξ 〉} d ξ , ∀ x ∈ {R}^{n} \qquad ( 54 )$$

One can rewrite the Fourier transform of Equation 53 in coordinates:

$$\hat{f} ( {ξ}_{1} , … , {ξ}_{n} ) = ℱ \{ f \} ( {ξ}_{1} , … , {ξ}_{n} ) = 1 / {( 2 π )}^{\frac{n}{2}} {\int }_{{R}^{n}} f ( {x}_{1} , … , {x}_{n} ) {e}^{- 2 π i ( {x}_{1} {ξ}_{1} + … + {x}_{n} {ξ}_{n} )} d {x}_{1} … {dx}_{n} \qquad ( 55 )$$

The discrete counterpart of Equation 53 transforms an n-dimensional complex signal ƒ(x)=ƒ(x₁, . . . , xₙ): Rⁿ→C at M₁× . . . ×Mₙ grid points into its complex Fourier modes via:

\hat{ƒ}(ξ₁, . . . , ξₙ)= [symbol] {ƒ}(ξ₁, . . . , ξₙ)=Σₘ_{₁}₌₀^{M}^{₁} . . . Σₘ_{ₙ}₌₀^{M}^{ₙ}ƒ(m₁, . . . ,mₙ)·e^{-2πi·(m}^{₁}^{ξ}^{₁}^{/M}^{₁}^{+ . . . +m}^{ₙ}^{ξ}^{ₙ}^{/M}^{ₙ}⁾ (56)

where (ξ₁, . . . , ξₙ)∈Z_{M1} . . . Z_{Mn}. Fast Fourier transforms (FFTs) immensely accelerate the computation of the transformations of Equation 56 by factorizing the discrete Fourier transform matrix into a product of sparse (mostly zero) factors.

Analogous to Equation 53, the Clifford Fourier transform and the respective inverse transform for multivector valued functions ƒ(x): R²→G² and vectors x, ξ∈R² are defined as:

\hat{ƒ}(ξ)= [symbol] {ƒ}(ξ)=1/(2π)∫_{R}_{ⁿ}ƒ(x)e^{-2πi}^{₂}^{<x,ξ>}dx,∀ξ∈R² (67)

ƒ(x)= [symbol] ⁻¹{ [symbol] {ƒ}}(x)=1/(2π)∫_{R}_{ⁿ}\hat{ƒ}(ξ)e^{2πi}^{₂}^{<x,ξ>}dξ,∀x∈R² (68)

provided that the integrals exist. The differences to Equations 53 and 54 are that ƒ(x) and \hat{ƒ}(ξ) represent multivector fields in the spatial and the frequency domain, respectively, and that the pseudoscalar i2=e1e2 is used in the exponent. Inserting the definition of multivector fields, one can rewrite Equation 57 as Equation 14.

The discretized versions of the spinor/vector part (\hat{ƒ}_{s/v}) reads analogously to Equation 56:

\hat{ƒ}_{s/v}(ξ₁,ξ₂)= [symbol] {ƒ_{s/v}}(ξ₁,ξ₂=Σₘ_{₁}₌₀^{M}^{₁} . . . Σₘ_{ₙ}₌₀^{M}^{ₙ}ƒ_{s/v}(m₁,m₂)·e^{-2πi·(m}^{₁}^{ξ}^{₁}^{/M}^{₁}^{+m}^{₂}^{ξ}^{₂}^{/M}^{₂}⁾ (60)

where again (ξ₁,ξ₂)∈Z_{M1}×Z_{Mn}. Similar to Fourier Neural Operators (FNOs) where weight tensors are applied pointwise in the Fourier space, one can apply multivector weight tensors W∈

(G²)^{c}^{ᵢₙ}^{×c}^{ₒᵤₜ}^{×(ξ}^{₁}^{^{max}}^{×ξ}^{₂}^{^{max}}⁾ point-wise. Fourier modes above cut-off frequencies (ξ₁^{max}, ξ₂^{max}) are set to zero. In doing so, one modifies the Clifford Fourier modes

\hat{ƒ}(ξ)= [symbol] {ƒ}(ξ)=\hat{ƒ}₀(ξ)+\hat{ƒ}₁(ξ)e₁+\hat{ƒ}₂(ξ)e₂+\hat{ƒ}₁₂(ξ)e₁₂ (61)

via the geometric product. The Clifford Fourier modes follow naturally when combining spinor and vector parts of Equation 59. Analogously to FNOs, higher order modes are cut off. Finally, the residual connections used in FNO layers is replaced by a multivector weight matrix realized as Clifford convolution, ideally a Cl_{2,0}(R) convolution layer.

What follows is proof of the 2D Clifford convolution theorem for multivector valued filters applied from the right, such that filter operations are consistent with Clifford convolution layers. First, it is shown that the Clifford kernel commutes with the spinor and anti-commutes with the vector part of multivectors. Write the product ae^{i2s} for every scalar s∈R and multivector a∈G² as

aeⁱ^{₂}^{s}=a(cos(s)+i₂ sin(s)) (62)

For the basis of the spinor part, note 1i₂=i₂1, and for the basis of the vector part e₁i₂=e₁e₁e₂=−e₁e₂e₁=−i₂e₁. Thus, the Fourier kernel

$${e}^{- {2}_{π i}} 2 〈 x , ξ 〉$$

commutes with the spinor part, and anti-commutes with the vector part of a. What follows is a proof of the convolution theorem for the commuting spinor and the anti-commuting vector part of a.

Let the field ƒ: R²→G² be multivector valued, the filter kₛ: R²→G² be spinor valued, and the filter kᵥ: R²→G² be vector valued, and let [symbol] {ƒ}, [symbol] {kₛ}, [symbol] {kᵥ} exist, then

$$\{ f ★ {k}_{s} \} ( ξ ) = \{ f \} ( ξ ) \cdot {†}^{} \{ {k}_{s} \} ( ξ ) , \{ f ★ {k}_{v} \} ( ξ ) = \{ f \} ( ξ ) \cdot \{ {k}_{v} \} ( ξ ) , w here {†}^{} \{ {k}_{s} \} ( ξ ) = \{ {k}_{s} \} ( - ξ ) and \{ {k}_{v} \} ( ζ ) = \{ {k}_{v} \} ( - ξ ) . \\ Proof : F \{ f ★ {k}_{s} \} ( ξ ) = 1 / {( 2 π )}^{2} {\int }_{{R}^{2}} [ {\int }_{{R}^{2}} f ( y ) {k}_{s} ( y - x ) d y ] {e}^{- 2 π {i}_{2} 〈 x , ξ 〉} dx = 1 / {( 2 π )}^{2} {\int }_{{R}^{2}} f ( y ) [ {\int }_{{R}^{2}} {k}_{s} ( y - x ) {e}^{- 2 π {i}_{2} 〈 y - x , ξ 〉} d x ] dy = 1 / {( 2 π )}^{2} {\int }_{{R}^{2}} f ( y ) [ {\underbrace{{\int }_{{R}^{2}} {k}_{2} ( y - x ) {e}^{- 2 π {i}_{2} 〈 x , ξ 〉} dx}}_{{F}^{†} \{ {k}_{s} \} ( ξ ) {e}^{- 2 π {i}_{2} 〈 y , ξ 〉} = {e}^{- 2 π {i}_{2} 〈 y , ξ 〉 {F}^{†} \{ {k}_{s} \} ( ξ )}} ] dy = 1 / ( 2 π ) [ {\int }_{{R}^{2}} f ( y ) {e}^{- 2 π {i}_{2} 〈 y , ξ 〉} dy ] {ℱ}^{†} \{ {k}_{s} \} ( ξ ) = ℱ \{ f \} ( ξ ) \cdot {F}^{†} \{ {k}_{s} \} ( ξ ) \qquad ( 63 )$$

$$ℱ \{ f ★ {k}_{v} \} ( ξ ) = 1 / {( 2 π )}^{2} {\int }_{{R}^{2}} [ {\int }_{{R}^{2}} f ( y ) {k}_{v} ( y - x ) dy ] {e}^{- 2 π {i}_{2} 〈 x , ξ 〉} dx = 1 / {( 2 π )}^{2} {\int }_{{R}^{2}} f ( y ) [ {\int }_{{R}^{2}} {k}_{v} ( y - x ) {e}^{- 2 π {i}_{2} 〈 y - x , ξ 〉} dx ] dy = 1 / {( 2 π )}^{2} {\int }_{{R}^{2}} f ( y ) [ {\underbrace{{\int }_{{R}^{2}} {k}_{v} ( y - x ) {e}^{- 2 π {i}_{2} 〈 x , ξ 〉} dx}}_{{F}^{†} \{ {k}_{v} \} ( ξ ) {e}^{- 2 π {i}_{2} 〈 y , ξ 〉} = {e}^{- 2 π {i}_{2} 〈 y , ξ 〉 {F}^{†} \{ {k}_{v} \} ( ξ )}} ] dy = 1 / ( 2 π ) [ {\int }_{{R}^{2}} f ( y ) {e}^{- 2 π {i}_{2} 〈 y , ξ 〉} dy ] ℱ \{ {k}_{v} \} ( ξ ) = ℱ \{ f \} ( ξ ) \cdot ℱ \{ {k}_{v} \} ( ξ ) \qquad ( 64 )$$

Analogous to Equation 53, the Clifford Fourier transform and the respective inverse transform for multivector valued functions ƒ: R³→G³ and vectors x, ξ∈R³ are defined as:

\hat{ƒ}(ξ)= [symbol] {ƒ}(ξ)=1/(2π)^{3/2}∫_{R}_{³}ƒ(x)e^{-2πi}^{₃}^{<x,ξ>}dx,∀ξ∈R³ (65)

ƒ(x)= [symbol] ⁻¹{ [symbol] {ƒ}}(x)=1/(2π)^{3/2}∫_{R}_{³}\hat{ƒ}(ξ)e^{2πi}^{₃}^{<x,ξ>}dξ,∀x∈R³ (66)

provided that the integrals exist. A multivector valued function ƒ: R³→G³,

ƒ=₀+ƒ₁e₁+ƒ₂e₂+ƒ₃e₃+ƒ₁₂e₁₂+ƒ₁₃e₁₃+ƒ₂₃e₂₃+ƒ₁₂₃e₁₂₃ (67)

can be expressed via the pseudoscalar i₃=e₁e₂e₃ as:

ƒ=(ƒ₀+ƒ₁₂₃i₃)1+(ƒ₁+ƒ₁₂₃i₃)e₁+(ƒ₂±ƒ₃₁i₃)e₂+(ƒ₃+ƒ₁₂i₃)e₃, (68)

One can obtain a 3-dimensional Clifford Fourier transform by applying four standard Fourier transforms for the four dual pairs ƒ₀=ƒ₀(x)+ƒ₁₂₃(x)i₃, ƒ₁=ƒ₁(x)+ƒ₂₃(x)i₃, ƒ₂=ƒ₂(x)+ƒ₃₁(x)i₃, and ƒ₃=ƒ₃(x)+ƒ₁₂(x)i₃, which all can be treated as a complex-valued signal ƒ₀, ƒ₁, ƒ₂, ƒ₃: R³→C. Consequently, ƒ(x) can be understood as an element of C⁴. The 3D Clifford Fourier transform is the linear combination of four classical Fourier transforms:

$$ℱ \{ f \} ( ξ ) = 1 / {( 2 π )}^{3 / 2} {\int }_{{R}^{3}} f ( x ) {e}^{- 2 π {i}_{3} 〈 x , ξ 〉} dx = 1 / {( 2 π )}^{\frac{3}{2}} {\int }_{{R}^{3}} [ 1 ( {f}_{0} ( x ) + {f}_{123} ( x ) {i}_{3} ) + {e}_{1} ( {f}_{1} ( x ) + {f}_{23} ( x ) {i}_{3} ) + {e}_{2} ( {f}_{2} ( x ) + {f}_{31} ( x ) {i}_{3} ) + {e}_{3} ( {f}_{3} ( x ) + {f}_{12} ( x ) {i}_{3} ) ] {e}^{- 2 π {i}_{3} 〈 x , ξ 〉} dx = 1 / {( 2 π )}^{\frac{3}{2}} {\int }_{{R}^{3}} 1 ( {f}_{0} ( x ) + {f}_{123} ( x ) {i}_{3} ) {e}^{- 2 π {i}_{3} 〈 x , ξ 〉} dx + 1 / {( 2 π )}^{\frac{3}{2}} {\int }_{{R}^{3}} {e}_{1} ( {f}_{1} ( x ) + {f}_{23} ( x ) {i}_{3} ) {e}^{- 2 π {i}_{3} 〈 x , ξ 〉} dx + 1 / {( 2 π )}^{\frac{3}{2}} {\int }_{{R}^{3}} {e}_{2} ( {f}_{2} ( x ) + {f}_{31} ( x ) {i}_{3} ) {e}^{- 2 π {i}_{3} 〈 x , ξ 〉} dx + 1 / {( 2 π )}^{\frac{3}{2}} {\int }_{{R}^{3}} {e}_{3} ( {f}_{3} ( x ) + {f}_{12} ( x ) {i}_{3} ) {e}^{- 2 π {i}_{3} 〈 x , ξ 〉} dx = 1 [ ℱ ( {f}_{0} ( x ) + {f}_{123} ( x ) {i}_{3} ) ( ξ ) ] + {e}_{1} [ ℱ ( {f}_{1} ( x ) + {f}_{23} ( x ) {i}_{3} ) ] + {e}_{2} [ ℱ ( {f}_{2} ( x ) + {f}_{31} ( x ) {i}_{3} ) ] + {e}_{3} [ F ( {f}_{3} ( x ) + {f}_{12} ( x ) {i}_{3} ) ] \qquad ( 69 )$$

Analogous to the 2-dimensional Clifford Fourier transform, one can apply multivector weight tensors W∈(G²)^{c}^{ᵢₙ}^{×c}^{ₒᵤₜ}^{×(ξ}^{₁}^{^{max}}^{×ξ}^{₂}^{^{max}}^{×ξ}^{₃}^{^{max}}⁾ point-wise. Fourier modes above cut-off frequencies (ξ₁^{max}, ξ₂^{max}, ξ₃^{max}) are set to zero. In doing so, one modifies the Clifford Fourier modes

\hat{ƒ}(ξ)= [symbol] {ƒ}(ξ)=\hat{ƒ}₀(ξ)+\hat{ƒ}₁(ξ)e₁+\hat{ƒ}₂(ξ)e₂+\hat{ƒ}₃(ξ)e₃+\hat{ƒ}₁₂(ξ)e₁₂+\hat{ƒ}₃₁(ξ)e₃₁+\hat{ƒ}₂₃(ξ)e₂₃+\hat{ƒ}₁₂₃(ξ)e₁₂₃ (70)

via the geometric product. The Clifford Fourier modes follow naturally when combining the four parts of Equation 69. Finally, the residual connections used in FNO layers is replaced by a multivector weight matrix realized as Clifford convolution, such as a Cl_{3,0}(R) convolution layer.

First, it is shown that the Clifford kernel commutes with the spinor and anti-commutes with the vector part of multivectors. Write the product aeⁱ^{₃}^{s} for every scalar s∈R and multivector a∈G³ as

aeⁱ^{₃}^{s}=a(cos(s)+i₃ sin(s)) (71)

In contrast to the 2-dimensional Clifford Fourier transform, now all four parts of the multivector of Equation 68 commute with i₃:

1i₃=i₃1

e₁i₃=e₁e₁e₂e₃=−e₁e₂e₁e₃=e₁e₂e₃e₁=i₃e₁

e₂i₃=e₂e₁e₂e₃=−e₁e₂e₂e₃=e₁e₂e₃e₂=i₃e₂

e₃i₃=e₃e₁e₂e₃=−e₁e₃e₂e₃=e₁e₂e₃e₃=i₃e₃. (72)

Let the field ƒ: R³→G³ be multivector valued, the filter kₐ: R³→G³ be multivector valued, and let [symbol] {ƒ}, [symbol] {kₐ} exist, then

$$\{ f ★ {k}_{a} \} ( ξ ) = \{ f \} ( ξ ) \cdot \{ {k}_{a} \} ( ξ ) where {†}^{} \{ {k}_{a} \} ( ξ ) = \{ {k}_{a} \} ( - ξ ) . \\ Proof : F \{ f ★ {k}_{a} \} ( ξ ) = 1 / {( 2 π )}^{3} {\int }_{{R}^{3}} [ {\int }_{{R}^{3}} f ( y ) {k}_{a} ( y - x ) d y ] {e}^{- 2 π {i}_{3} 〈 x , ξ 〉} dx = 1 / {( 2 π )}^{3} {\int }_{{R}^{3}} f ( y ) [ {\int }_{{R}^{3}} {k}_{a} ( y - x ) {e}^{- 2 π {i}_{3} 〈 y - x , ξ 〉} d x ] dy = 1 / {( 2 π )}^{3} {\int }_{{R}^{3}} f ( y ) [ {\underbrace{{\int }_{{R}^{3}} {k}_{a} ( y - x ) {e}^{- 2 π {i}_{3} 〈 x , ξ 〉} dx}}_{{F}^{†} \{ {k}_{a} \} ( ξ ) {e}^{- 2 π {i}_{3} 〈 y , ξ 〉} = {e}^{- 2 π {i}_{3} 〈 y , ξ 〉 {F}^{†} \{ {k}_{a} \} ( ξ )}} ] dy = 1 / {( 2 π )}^{3 / 2} [ {\int }_{{R}^{3}} f ( y ) {e}^{- 2 π {i}_{3} 〈 y , ξ 〉} dy ] {ℱ}^{†} \{ {k}_{a} \} ( ξ ) = ℱ \{ f \} ( ξ ) \cdot {F}^{†} \{ {k}_{a} \} ( ξ ) \qquad ( 73 )$$

One can implement a 2D Clifford Fourier layer by applying two standard Fourier transforms on the dual pairs of Equation 14. These dual pairs can be treated as complex valued inputs. Similarly, one implement a 3D Clifford Fourier layer by applying four standard Fourier transforms on the dual pairs of, for example, Cl_{3,0} Equations 40-Equation 43). Since Clifford convolution theorems hold both for the vector and the spinor parts and for the four dual pairs for Cl_{2,0} and Cl_{3,0}, respectively, we multiply the modes in the Fourier space using the geometric product. Finally, we apply an inverse Fourier transformation and resemble the multivectors in the spatial domain.

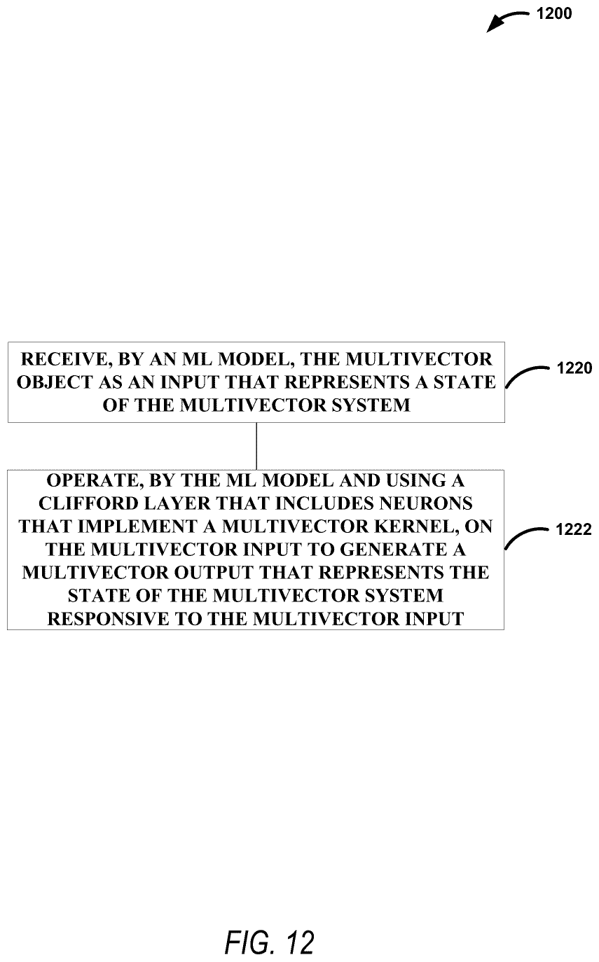

FIG. 12 illustrates, by way of example, a diagram of an embodiment of a method 1200 for machine learning (ML) modeling of a multivector system that operates on a multivector object. The method 1200 as illustrated includes receiving, by an ML model, the multivector object as an input that represents a state of the multivector system, at operation 1220; and operating, by the ML model and using a Clifford layer that includes neurons that implement a multivector kernel, on the multivector input to generate a multivector output that represents the state of the multivector system responsive to the multivector input, at operation 1222. The multivector input represents a change in state (e.g., stimulus) in the multivector system.

The method 1200 can further include, wherein the Clifford layer is a Clifford Fourier layer, a Clifford convolution layer, or an equivariant Clifford convolution layer. The method 1200 can further include, wherein the Clifford layer is a Clifford Fourier Neural Operator (FNO) that includes a Clifford Fourier layer and a Clifford convolution layer. The method 1200 can further include, wherein the multivector system is an electromagnetic field or a dynamic fluid. The method 1200 can further include, wherein the Clifford layer is a Clifford convolution and the method further comprises constraining a kernel for a Clifford convolution layer such that the Clifford convolution layer is equivariant.

The method 1200 can further include, wherein the multivector object includes two or more of a scalar, a vector, a bi-vector, or a tri-vector. The method 1200 can further include, wherein the multivector object includes the vector. The method 1200 can further include, wherein the multivector object includes the bi-vector. The method 1200 can further include, wherein the multivector object includes the tri-vector.

Artificial Intelligence (AI) is a field concerned with developing decision-making systems to perform cognitive tasks that have traditionally required a living actor, such as a person. Neural networks (NNs) are computational structures that are loosely modeled on biological neurons. Generally, NNs encode information (e.g., data or decision making) via weighted connections (e.g., synapses) between nodes (e.g., neurons). Modern NNs are foundational to many AI applications, such as object or condition recognition, device behavior modeling or the like. The ML model 102 or a portion thereof, such as the Clifford neural layer 108, can include or be implemented using one or more NNs.

Many NNs are represented as matrices of weights (sometimes called parameters) that correspond to the modeled connections. NNs operate by accepting data into a set of input neurons that often have many outgoing connections to other neurons. At each traversal between neurons, the corresponding weight modifies the input and is tested against a threshold at the destination neuron. If the weighted value exceeds the threshold, the value is again weighted, or transformed through a nonlinear function, and transmitted to another neuron further down the NN graph—if the threshold is not exceeded then, generally, the value is not transmitted to a down-graph neuron and the synaptic connection remains inactive. The process of weighting and testing continues until an output neuron is reached; the pattern and values of the output neurons constituting the result of the NN processing.

The optimal operation of most NNs relies on accurate weights. However, NN designers do not generally know which weights will work for a given application. NN designers typically choose a number of neuron layers or specific connections between layers including circular connections. A training process may be used to determine appropriate weights by selecting initial weights.

In some examples, initial weights may be randomly selected. Training data is fed into the NN, and results are compared to an objective function that provides an indication of error. The error indication is a measure of how wrong the NN's result is compared to an expected result. This error is then used to correct the weights. Over many iterations, the weights will collectively converge to encode the operational data into the NN. This process may be called an optimization of the objective function (e.g., a cost or loss function), whereby the cost or loss is minimized.

A gradient descent technique is often used to perform objective function optimization. A gradient (e.g., partial derivative) is computed with respect to layer parameters (e.g., aspects of the weight) to provide a direction, and possibly a degree, of correction, but does not result in a single correction to set the weight to a “correct” value. That is, via several iterations, the weight will move towards the “correct,” or operationally useful, value. In some implementations, the amount, or step size, of movement is fixed (e.g., the same from iteration to iteration). Small step sizes tend to take a long time to converge, whereas large step sizes may oscillate around the correct value or exhibit other undesirable behavior. Variable step sizes may be attempted to provide faster convergence without the downsides of large step sizes.

Backpropagation is a technique whereby training data is fed forward through the NN—here “forward” means that the data starts at the input neurons and follows the directed graph of neuron connections until the output neurons are reached—and the objective function is applied backwards through the NN to correct the synapse weights. At each step in the backpropagation process, the result of the previous step is used to correct a weight. Thus, the result of the output neuron correction is applied to a neuron that connects to the output neuron, and so forth until the input neurons are reached. Backpropagation has become a popular technique to train a variety of NNs. Any well-known optimization algorithm for back propagation may be used, such as stochastic gradient descent (SGD), Adam, etc.

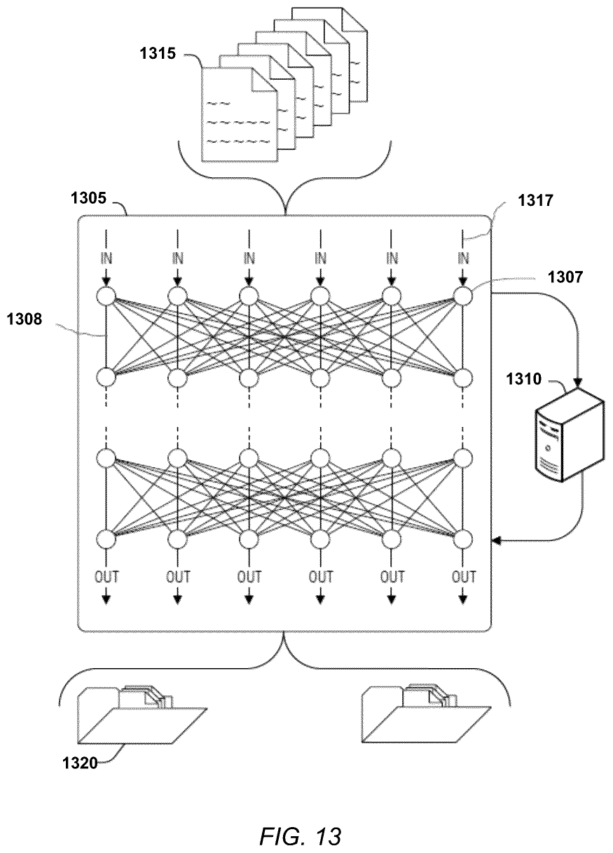

FIG. 13 is a block diagram of an example of an environment including a system for neural network training. One or more of Clifford neural layers and other parts of an ML model discussed herein can be at least partially implemented using the system of FIG. 13. The system includes an artificial NN (ANN) 1305 that is trained using a processing node 1310. The processing node 1310 may be a central processing unit (CPU), graphics processing unit (GPU), field programmable gate array (FPGA), digital signal processor (DSP), application specific integrated circuit (ASIC), or other processing circuitry. In an example, multiple processing nodes may be employed to train different layers of the ANN 1305, or even different nodes 1307 within layers. Thus, a set of processing nodes 1310 is arranged to perform the training of the ANN 1305.

The set of processing nodes 1310 is arranged to receive a training set 1315 for the ANN 1305. The ANN 1305 comprises a set of nodes 1307 arranged in layers (illustrated as rows of nodes 1307) and a set of inter-node weights 1308 (e.g., parameters) between nodes in the set of nodes. In an example, the training set 1315 is a subset of a complete training set. Here, the subset may enable processing nodes with limited storage resources to participate in training the ANN 1305.

The training data may include multiple numerical values representative of a domain, such as an image feature, or the like. Each value of the training or input 1317 to be classified after ANN 1305 is trained, is provided to a corresponding node 1307 in the first layer or input layer of ANN 1305. The values propagate through the layers and are changed by the objective function.

As noted, the set of processing nodes is arranged to train the neural network to create a trained neural network. After the ANN is trained, data input into the ANN will produce valid classifications 1320 (e.g., the input data 1317 will be assigned into categories), for example. The training performed by the set of processing nodes 1307 is iterative. In an example, each iteration of the training the ANN 1305 is performed independently between layers of the ANN 1305. Thus, two distinct layers may be processed in parallel by different members of the set of processing nodes. In an example, different layers of the ANN 1305 are trained on different hardware. The members of different members of the set of processing nodes may be located in different packages, housings, computers, cloud-based resources, etc. In an example, each iteration of the training is performed independently between nodes in the set of nodes. This example is an additional parallelization whereby individual nodes 1307 (e.g., neurons) are trained independently. In an example, the nodes are trained on different hardware.

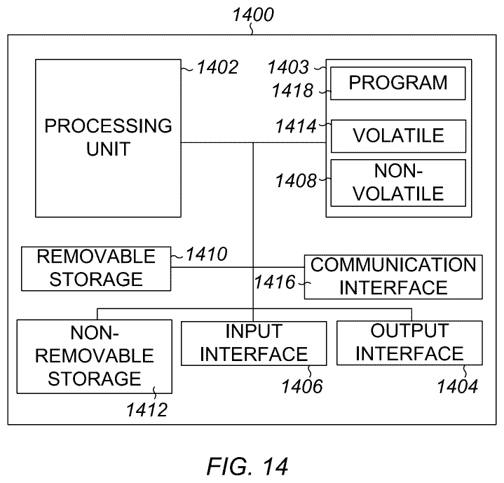

FIG. 14 illustrates, by way of example, a block diagram of an embodiment of a machine 1400 (e.g., a computer system) to implement one or more embodiments. One or more of the ML model 102, Clifford neural layer 108, Clifford convolution layer 600, Clifford FNO layer 700, the method 1200, the training system of FIG. 13, or a component or operations thereof can be implemented, at least in part, using a component of the machine 1400. One example machine 1400 (in the form of a computer), may include a processing unit 1402, memory 1403, removable storage 1410, and non-removable storage 1412. Although the example computing device is illustrated and described as machine 1400, the computing device may be in different forms in different embodiments. For example, the computing device may instead be a smartphone, a tablet, smartwatch, or other computing device including the same or similar elements as illustrated and described regarding FIG. 14. Further, although the various data storage elements are illustrated as part of the machine 1400, the storage may also or alternatively include cloud-based storage accessible via a network, such as the Internet.

Memory 1403 may include volatile memory 1414 and non-volatile memory 1408. The machine 1400 may include—or have access to a computing environment that includes—a variety of computer-readable media, such as volatile memory 1414 and non-volatile memory 1408, removable storage 1410 and non-removable storage 1412. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices capable of storing computer-readable instructions for execution to perform functions described herein.

The machine 1400 may include or have access to a computing environment that includes input 1406, output 1404, and a communication connection 1416. Output 1404 may include a display device, such as a touchscreen, that also may serve as an input component. The input 1406 may include one or more of a touchscreen, touchpad, mouse, keyboard, camera, one or more device-specific buttons, one or more sensors integrated within or coupled via wired or wireless data connections to the machine 1400, and other input components. The computer may operate in a networked environment using a communication connection to connect to one or more remote computers, such as database servers, including cloud-based servers and storage. The remote computer may include a personal computer (PC), server, router, network PC, a peer device or other common network node, or the like. The communication connection may include a Local Area Network (LAN), a Wide Area Network (WAN), cellular, Institute of Electrical and Electronics Engineers (IEEE) 802.11 (Wi-Fi), Bluetooth, or other networks.

Computer-readable instructions stored on a computer-readable storage device are executable by the processing unit 1402 (sometimes called processing circuitry) of the machine 1400. A hard drive, CD-ROM, and RANI are some examples of articles including a non-transitory computer-readable medium such as a storage device. For example, a computer program 1418 may be used to cause processing unit 1402 to perform one or more methods or algorithms described herein.

The operations, functions, or algorithms described herein may be implemented in software in some embodiments. The software may include computer executable instructions stored on computer or other machine-readable media or storage device, such as one or more non-transitory memories (e.g., a non-transitory machine-readable medium) or other type of hardware-based storage devices, either local or networked. Further, such functions may correspond to subsystems, which may be software, hardware, firmware, or a combination thereof. Multiple functions may be performed in one or more subsystems as desired, and the embodiments described are merely examples. The software may be executed on processing circuitry, such as can include a digital signal processor, ASIC, microprocessor, central processing unit (CPU), graphics processing unit (GPU), field programmable gate array (FPGA), or other type of processor operating on a computer system, such as a personal computer, server, or other computer system, turning such computer system into a specifically programmed machine. The processing circuitry can, additionally or alternatively, include electric and/or electronic components (e.g., one or more transistors, resistors, capacitors, inductors, amplifiers, modulators, demodulators, antennas, radios, regulators, diodes, oscillators, multiplexers, logic gates, buffers, caches, memories, GPUs, CPUs, field programmable gate arrays (FPGAs), or the like). The terms computer-readable medium, machine readable medium, and storage device do not include carrier waves or signals to the extent carrier waves and signals are deemed too transitory.

### ADDITIONAL NOTES AND EXAMPLES

Example 1 includes a method for machine learning (ML) modeling of a multivector system that operates on a multivector object, the method comprising receiving, by an ML model, the multivector object as an input that represents a state of the multivector system, and operating, by the ML model and using a Clifford layer that includes neurons that implement a multivector kernel, on the multivector input to generate a multivector output that represents the state of the multivector system responsive to the multivector input.

In Example 2, Example 1 further includes, wherein the Clifford layer is a Clifford Fourier layer, a Clifford convolution layer, or an equivariant Clifford convolution layer.

In Example 3, at least one of Examples 1-2 further includes, wherein the Clifford layer is a Clifford Fourier Neural Operator (FNO) that includes a Clifford Fourier layer and a Clifford convolution layer.

In Example 4, at least one of Examples 1-3 further includes, wherein the multivector system is an electromagnetic field or a dynamic fluid.

In Example 5, at least one of Examples 1-4 further includes, wherein the multivector object includes two or more of a scalar, a vector, a bi-vector, or a tri-vector.

In Example 6, Example 5 further includes, wherein the multivector object includes the vector.

In Example 7, at least one of Examples 5-6 further includes, wherein the multivector object includes the bi-vector.

In Example 8, at least one of Examples 5-7 further includes, wherein the multivector object includes the tri-vector.

In Example 9, at least one of Examples 1-8 further includes, wherein the Clifford layer is a Clifford convolution and the method further comprises constraining a kernel for a Clifford convolution layer such that the Clifford convolution layer is equivariant.

Example 10 includes a system comprising processing circuitry and one or more memories including parameters for neurons trained for machine learning (ML) modeling of a multivector system that operates on a multivector object and instructions that, when executed by the processing circuitry, cause the processing circuitry to perform operations for implementing an ML model using the method of one of Examples 1-9.

Example 11 includes a computer-readable medium including instructions that, when executed by a machine, cause the machine to perform the method of one of claims 1-9.

Although a few embodiments have been described in detail above, other modifications are possible. For example, the logic flows depicted in the figures do not require the order shown, or sequential order, to achieve desirable results. The desirable for embodiments can include the user having confidence in the state of their data, settings, controls, and secrets before, during, and after a migration to a new version of an application. Using multiple factors to check data state, integrity, presence, and absence before and after the migration can increase confidence. Other steps may be provided, or steps may be eliminated, from the described flows, and other components may be added to, or removed from, the described systems. Other embodiments may be within the scope of the following claims.

What is claimed is:

1. A method for machine learning (ML) modeling of a multivector system that operates on a multivector object, the method comprising:
receiving, by an ML model, the multivector object as an input that represents a state of the multivector system; and
operating, by the ML model and using a Clifford layer that includes neurons that implement a multivector kernel, on the multivector input to generate a multivector output that represents the state of the multivector system responsive to the multivector input.

2. The method of claim 1, wherein the Clifford layer is a Clifford Fourier layer, a Clifford convolution layer, or an equivariant Clifford convolution layer.

3. The method of claim 1, wherein the Clifford layer is a Clifford Fourier Neural Operator (FNO) that includes a Clifford Fourier layer and a Clifford convolution layer.

4. The method of claim 1, wherein the multivector system is an electromagnetic field or a dynamic fluid.

5. The method of claim 1, wherein the multivector object includes two or more of a scalar, a vector, a bi-vector, or a tri-vector.

6. The method of claim 5, wherein the multivector object includes the vector.

7. The method of claim 5, wherein the multivector object includes the bi-vector.

8. The method of claim 5, wherein the multivector object includes the tri-vector.

9. The method of claim 1, wherein the Clifford layer is a Clifford convolution and the method further comprises constraining a kernel for a Clifford convolution layer such that the Clifford convolution layer is equivariant.

10. A system comprising:
processing circuitry; and
one or more memories including parameters for neurons trained for machine learning (ML) modeling of a multivector system that operates on a multivector object and instructions that, when executed by the processing circuitry, cause the processing circuitry to perform operations for implementing an ML model, the operations comprising:
receiving, by the ML model, the multivector object as an input that represents a state of the multivector system; and
operating, by a Clifford layer of the ML model that includes neurons that implement a multivector kernel, on the multivector input to generate a multivector output that represents the state of the multivector system responsive to the multivector input.

11. The system of claim 10, wherein the Clifford layer is a Clifford Fourier layer, a Clifford convolution layer, or an equivariant Clifford convolution layer.

12. The system of claim 10, wherein the Clifford layer is a Clifford Fourier Neural Operator (FNO) that includes a Clifford Fourier layer and a Clifford convolution layer.

13. The system of claim 10, wherein the multivector system is an electromagnetic field or a dynamic fluid.

14. The system of claim 10, wherein the multivector object includes two or more of a scalar, a vector, a bi-vector, or a tri-vector.

15. The system of claim 10, wherein the Clifford layer is a Clifford convolution and the method further comprises constraining a kernel for a Clifford convolution layer such that the Clifford convolution layer is equivariant.

16. A computer-readable medium including instructions that, when executed by a machine, cause the machine to perform operations for implementing a machine learning (ML) model that models a multivector system that operates on a multivector object, the operations comprising:
receiving, by the ML model, the multivector object as an input that represents a state of the multivector system; and
operating, by a Clifford layer of the ML model that includes neurons that implement a multivector kernel, on the multivector input to generate a multivector output that represents the state of the multivector system responsive to the multivector input.

17. The computer-readable medium of claim 16, wherein the Clifford layer is a Clifford Fourier layer, a Clifford convolution layer, or an equivariant Clifford convolution layer.

18. The computer-readable medium of claim 16, wherein the Clifford layer is a Clifford Fourier Neural Operator (FNO) that includes a Clifford Fourier layer and a Clifford convolution layer.

19. The computer-readable medium of claim 16, wherein the multivector system is an electromagnetic field or a dynamic fluid.

20. The computer-readable medium of claim 16, wherein the multivector object includes two or more of a scalar, a vector, a bi-vector, or a tri-vector.
